(19) United States
(12) Patent Application Publication
(10) Pub. No.: US 2009/0317733 A1
(43) Pub. Date: Dec. 24, 2009

(54) Quinone Compound, Electrophotographic Photoconductor and Electrophotographic Apparatus

(75) Inventors: Kenichi Okura, Nagano (JP); Yoichi Nakamura, Nagano (JP); Motohiro Takeshima, Yamanashi (JP); Yoshiki Hasegawa, Kanagawa (JP); Hiroyuki Kenmochi, Kanagawa (JP); Tohru Kobayashi, Kanagawa (JP)

Correspondence Address: RABIN & Berdo, PC, 1101 14TH STREET, NW, SUITE 500, WASHINGTON, DC, 20005, US

(73) Assignee: Fuji Electric Device Technology Co., Ltd., TOKYO (JP)

(21) Appl. No.: 12/087,890

(22) PCT Filed: Jan. 17, 2007
(86) PCT No.: PCT/JP2007/050574

§ 371 Date: Oct. 1, 2008

(30) Foreign Application Priority Data
Jan. 18, 2006 (JP) 2006-010183

(51) Int. Cl. G03G 15/00; G03G 5/047

(52) U.S. Cl. 430/56; 399/159; 430/58.25

(57) ABSTRACT

Disclosed is a compound having excellent electron transporting ability, which is useful for electrophotographic photosensitive bodies or organic EL devices. Specifically disclosed is a novel quinone compound having a structure represented by general formula (I). Also disclosed is a highly sensitive, positive charge type electrophotographic photosensitive body for copying machines and printers, wherein the novel organic material is used as a charge-transporting material in a photosensitive layer. Also specifically disclosed is an electrophotographic photosensitive body having a photosensitive layer formed on a conductive base and containing a charge-generating material and a charge-transporting material, wherein the photosensitive layer contains at least one of the above-described compounds. Further disclosed is an electrophotographic apparatus using such a positive charge type electrophotographic photosensitive body.

### CROSS-REFERENCE TO RELATED APPLICATIONS

This Application is the U.S. national stage of PCT Application No. PCT/JP20007/050574 filed on Jan. 17, 2007, the contents of which are incorporated herein by reference.

### BACKGROUND OF THE INVENTION

1. Field of the Invention

The present invention relates to a novel quinone compound, and more particularly, to a novel quinone compound useful as a charge transport material for an electrophotographic photoconductor (hereinafter simply referred to as “photoconductor”). The present invention also relates to an electrophotographic photoconductor and an electrophotographic apparatus, and more particularly, to an electrophotographic photoconductor used in electrophotographic printers, photocopiers and the like provided with a photosensitive layer containing an organic material on an electrically conductive substrate, and to an electrophotographic apparatus using the same.

2. Background of the Related Art

Inorganic photoconductive substances such as selenium or selenium alloys or inorganic photoconductive substances such as zinc oxide or cadmium sulfide dispersed in resin binders have conventionally been used as photosensitive layers of electrophotographic photoconductors. In recent years, research on electrophotographic photoconductors using organic photoconductive substances has progressed resulting in improvements in sensitivity, durability and the like that has enabled some of these to be used practically.

Photoconductors are required to have a function that enables them to retain surface charge in the dark, and a function that enables them to transport a charge by absorbing light. These photoconductors consist of so-called single-layer photoconductors, which possess both of these functions in a single layer, and so-called multilayer photoconductors, in which these functions are separated into a layer that mainly contributes to generation of charge and a layer that contributes to retaining surface charge in the dark and transporting charge during absorption of light.

An example of a process applied for forming images by electrophotography using these photoconductors is the Carson process. In this process, image formation is carried out by charging the photoconductor by corona discharge in the dark, forming an electrostatic latent image such as characters or pictures of a copy on the surface of the charged photoconductor, developing the formed electrostatic latent image with toner, and fixing the developed toner image on a carrier such as paper, and following transfer of the toner image, the photoconductor is reused after carrying out erase, removal of residual toner and optical erase.

Practically used organic photoconductors offer advantages over inorganic photoconductors in terms of flexibility, film formability, low cost, safety and the like, and are being further improved with respect to sensitivity, durability and the like because of the diversity of the materials.

Most of organic photoconductors are multilayer organic photoconductors in which functions are separated into a charge generation layer and a charge transport layer. In typical multilayer organic photoconductors, a charge generation layer containing a charge generation material such as a pigment or dye, and a charge transport layer containing a charge transport material such as hydrazone or triphenylamine, are formed in this order on an electrically conductive substrate, are of the hole-transporting type because the charge transport material is an electron donor, and have sensitivity when the surface of the photoconductor is negatively charged. In the case of negative charge types, however, corona discharge used during charging is less stable than positive charge types, and due to the generation of ozone, nitrogen oxides and the like, these substances adhere to the photoconductor surface resulting in increased susceptibility to physical and chemical deterioration, while also resulting in the problem of damage to the environment. In consideration of these points, positive charge type photoconductors, having a greater degree of freedom in usage conditions, are more advantageous as photoconductors and have a wider application range than negative charge type photoconductors.

Therefore, a method has been proposed that uses a positive charge type photoconductor by forming a single-layer photosensitive layer by simultaneously dispersing a charge generation material and a charge transport material in a resin binder for use as a positive charge type photoconductor, and some of these single-layer photosensitive layers are used practically. However, since single-layer photoconductors do not have adequate sensitivity for application to high-speed apparatuses, and require further improvement with respect to repetition characteristics and the like.

In addition, although a method has been considered for obtaining a multilayer structure having separate functions for each layer for the purpose of achieving high sensitivity consisting of forming a photoconductor by laminating a charge generation layer on a charge transport layer and using as a positive charge type of photoconductor, since the charge generation layer is formed on the surface in this method, problems such as that with respect to stability during repeated use are caused by corona discharge, light irradiation and mechanical wear. In this case, although the further providing of a protective layer on the charge generation layer has been proposed, even though mechanical wear is improved, problems such as that leading to a decrease in sensitivity and other electrical characteristics are not overcome.

Moreover, a method has also been proposed consisting of forming a photoconductor by laminating a charge transport layer capable of electron transport on a charge generation layer.

Although 2,4,7-trinitro-9-fluorenone is known to be an example of a charge transport material capable of electron transport, since this substance is carcinogenic, it has problems in terms of safety. In addition, quinone-based compounds have also been proposed (see Japanese Patent Application Laid-open Nos. H1-206349; H3-290666; H8-278643; H9-190002; H9-190003; 2001-222122; 2003-270817; and 2003-270818), and various photoconductors containing other substances having superior electron transport properties have also been proposed (see for example Japanese Patent Application Laid-open Nos. 2000-143607; 2000-199979; 2001-215742; 2002-62673; 2003-228185; and 2003-238561).

As has been described above, although various studies have been conducted on charge transport materials capable of transporting electrons, there is a need to realize photoconductors offering even higher performance by using novel charge transport materials having superior electron transport abilities in response to a recent demand for high-sensitivity photoconductors.

Therefore, an object of the present invention is to provide a compound having superior electron transport ability useful in applications such as electrophotographic photoconductors and organic electroluminescence (EL), and to provide a positive charge type of electrophotographic photoconductor for high-sensitivity photocopiers and printers, and an electrophotographic apparatus using the same, by using this novel organic material as a charge transport material in a photosensitive layer.

### SUMMARY OF THE INVENTION

As a result of conducting extensive studies on various types of organic materials to achieve the above-mentioned objects, the inventors of the present invention found that specific compounds represented by the following general formula (I) have superior electron transport properties, and that by using these compounds as a charge transport material, a high-sensitivity photoconductor capable of being used with a positive charge can be obtained, thereby leading to completion of the present invention.

Namely, in order to overcome the above-mentioned problems, a novel quinone compound of the present invention has a structure represented by general formula (I):

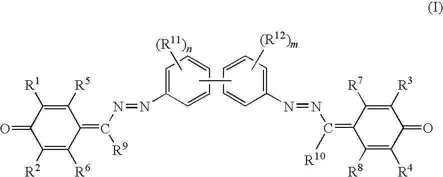

wherein R¹ to R⁸ may be the same or different and represent a hydrogen atom or an optionally substituted alkyl group or a cycloalkyl group having 1 to 6 carbon atoms, R⁹ and R¹⁰ may be the same or different and represent a hydrogen atom, an optionally substituted alkyl group having 1 to 6 carbon atoms, an optionally substituted aryl group or an optionally substituted heterocyclic group, R¹ and R⁵, R² and R⁶, R³ and R⁷ and R⁴ and R⁸ may be mutually bonded to form a ring, R¹¹ and R¹² may be the same or different and represent a halogen atom, an optionally substituted alkyl group having 1 to 6 carbon atoms, an alkoxy group having 1 to 6 carbon atoms, an alkyl halide group having 1 to 6 carbon atoms, an hydroxyl group, a nitro group,an optionally substituted aryl group or an optionally substituted heterocyclic group, n and m represent integers of 0 to 4, two or more R¹¹ may be the same or different and two or more R¹¹ may be mutually bonded to form a ring in the case n is 2 or more, two or more R¹² may be the same or different and two or more R¹² may be mutually bonded to form a ring in the case m is 2 or more, and substituents represent halogen atoms, alkyl groups having 1 to 6 carbon atoms, alkoxy groups having 1 to 6 carbon atoms, alkyl halide groups having 1 to 6 carbon atoms, hydroxyl groups, nitro groups, aryl groups or heterocyclic groups.

In addition, an electrophotographic photoconductor of the present invention is an electrophotographic photoconductor comprising an electrically conductive substrate; and a photosensitive layer containing a charge generation material and a charge transport material provided on the electrically conductive substrate, wherein the photosensitive layer contains at least one type of compound having a structure represented by general formula (I):

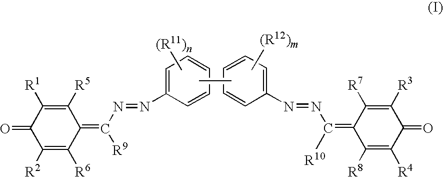

wherein R¹ to R⁸ may be the same or different and represent a hydrogen atom or an optionally substituted alkyl group or a cycloalkyl group having 1 to 6 carbon atoms, R⁹ and R¹⁰ may be the same or different and represent a hydrogen atom, an optionally substituted alkyl group having 1 to 6 carbon atoms, an optionally substituted aryl group or an optionally substituted heterocyclic group, R¹ and R⁵, R² and R⁶, R³ and R⁷ and R⁴ and R⁸ may be mutually bonded to form a ring, R¹¹ and R¹² may be the same or different and represent a halogen atom, an optionally substituted alkyl group having 1 to 6 carbon atoms, an alkoxy group having 1 to 6 carbon atoms, an alkyl halide group having 1 to 6 carbon atoms, an hydroxyl group, a nitro group, an optionally substituted aryl group or an optionally substituted heterocyclic group, n and m represent integers of 0 to 4, two or more R¹¹ may be the same or different and two or more R¹¹ may be mutually bonded to form a ring in the case n is 2 or more, two or more R¹² may be the same or different and two or more R¹² may be mutually bonded to form a ring in the case m is 2 or more, and substituents represent halogen atoms, alkyl groups having 1 to 6 carbon atoms, alkoxy groups having 1 to 6 carbon atoms, alkyl halide groups having 1 to 6 carbon atoms, hydroxyl groups, nitro groups, aryl groups or heterocyclic groups.

In the photoconductor of the present invention, the photosensitive layer is preferably a single-layer photosensitive layer containing a charge generation material, a charge transport material and a resin binder, wherein the charge transport material comprises an electron transport material and a hole transport material, and wherein the electron transport material comprises at least one type of compound having a structure represented by general formula (I), and can be particularly preferably applied to an electrophotographic apparatus which carries out a positive charging process.

In addition, in the photoconductor of the present invention, although a known hole transport material like that described in Japanese Patent Application Laid-open No. 2000-314969, for example, can be used as the hole transport material in the photosensitive layer, a styryl compound is particularly preferably contained.

Moreover, in the photoconductor of the present invention, although a known charge generation material can be used as the charge generation material in the photosensitive layer, a phthalocyanine compound is contained particularly preferably. Preferable examples of phthalocyanine compounds include, but are not limited to, X-type metal-free phthalocyanine, α-type titanyl phthalocyanine and Y-type titanyl phthalocyanine described in, for example, Japanese Patent Application Laid-open No. 2001-228637, and titanyl phthalocyanine as claimed in the invention described in Japanese Patent Application Laid-open No. 2001-330972.

In addition, an electrophotographic apparatus of the present invention is provided with the electrophotographic photoconductor of the present invention and carries out the charging process by a positive charging process.

According to the present invention, a compound having superior electron transport properties can be obtained, and electrical characteristics and the like can be improved by applying this compound to electrophotographic photoconductors or electronic devices using organic compounds such as organic EL.

In addition, according to the present invention, in an electrophotographic photoconductor provided with a photosensitive layer on an electrically conductive substrate, electron transport properties are improved by containing a specific compound having electron transport properties as an electron transport material in the photosensitive layer, which together with demonstrating superior electrical characteristics, also demonstrates the effect of superior repeat stability due to a reduction in charge trapping.

Thus, according to the present invention, a highly durable electrophotographic photoconductor can be obtained having superior electrical characteristics and repeat stability, and this electrophotographic photoconductor is useful in electrophotographic apparatuses using electrophotographic systems such as printers, photocopiers and fax machines.

### BRIEF DESCRIPTION OF THE DRAWINGS

FIG. 1 is a schematic cross-sectional view showing the general configuration of an electrophotographic photoconductor;

FIG. 2 is a schematic cross-sectional view showing an example of the configuration of a single-layer electrophotographic photoconductor;

FIG. 3 is a schematic cross-sectional view showing another example of the configuration of a single-layer electrophotographic photoconductor;

FIG. 4 is a schematic cross-sectional view showing an example of the configuration of a multilayer electrophotographic photoconductor;

FIG. 5 is a schematic cross-sectional view showing another example of the configuration of a multilayer electrophotographic photoconductor; and

FIG. 6 is schematic cross-sectional view showing still another example of the configuration of a multilayer electrophotographic photoconductor.

### DETAILED DESCRIPTION OF THE INVENTION

Although specific example of compounds represented by the general formula (I) are illustrated with the following structural formulas (I-1) to (I-160), the present invention is not limited to these compounds. Furthermore, the symbol+in the specific examples illustrated below represents a t-butyl group.

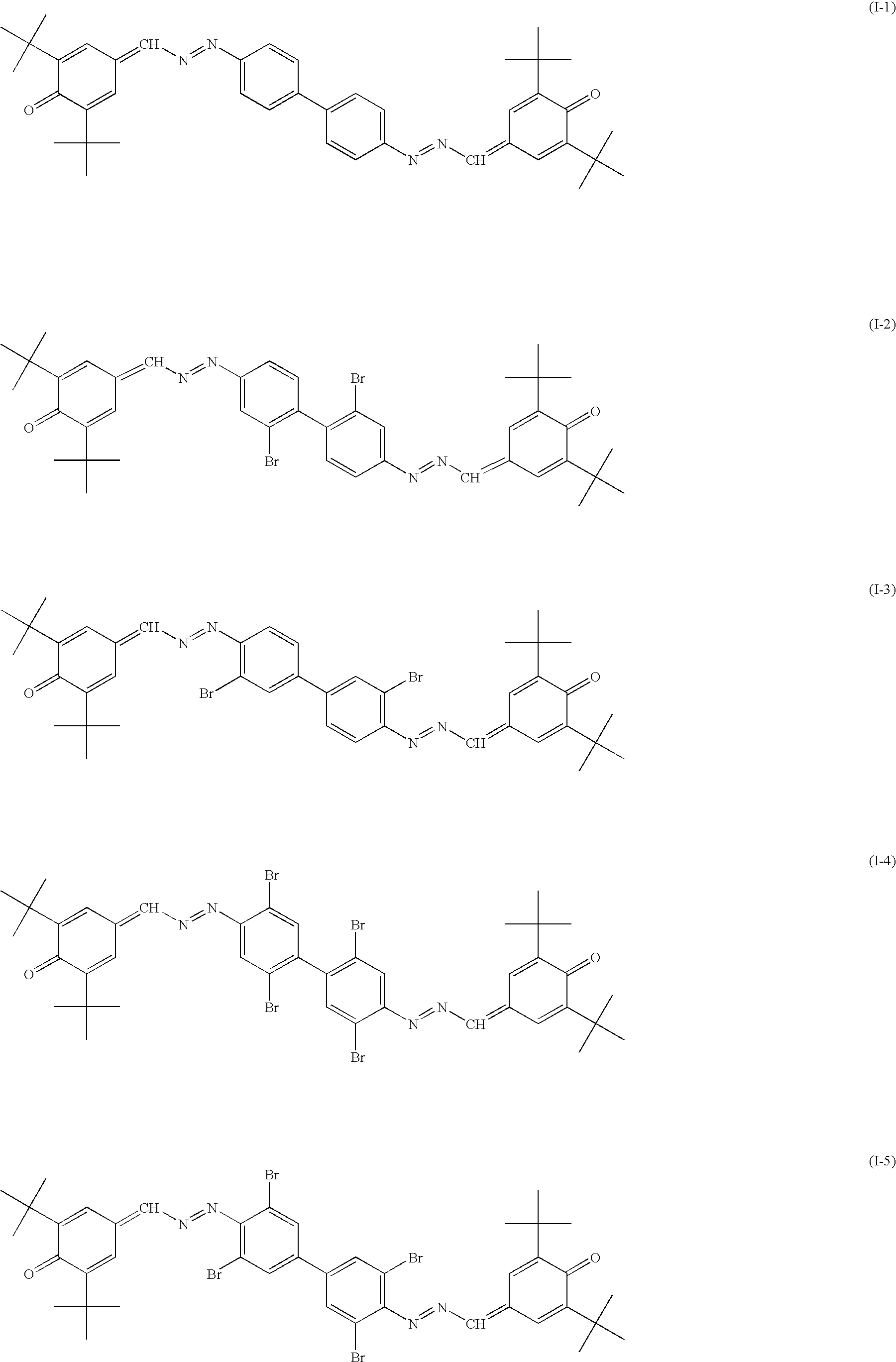

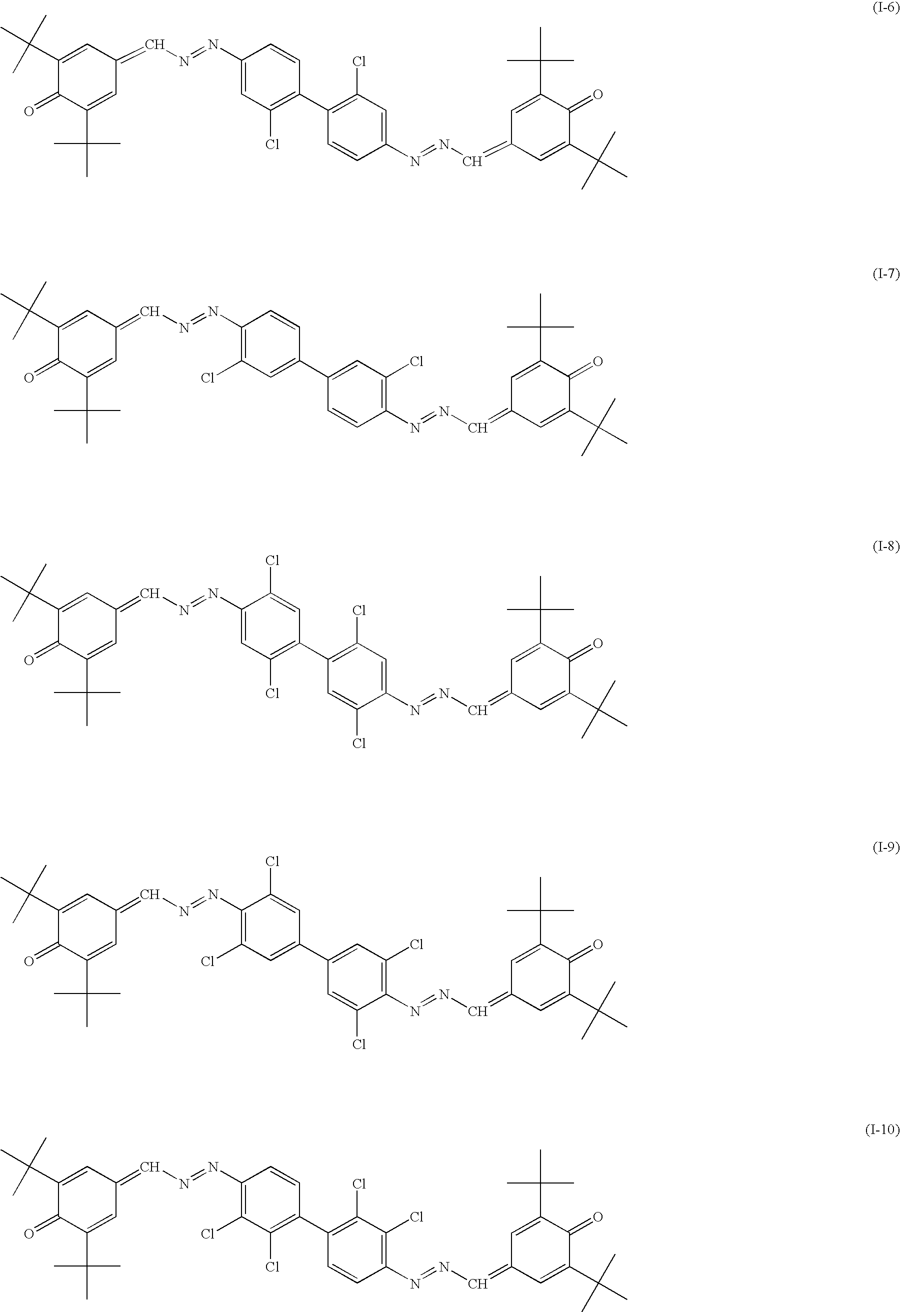

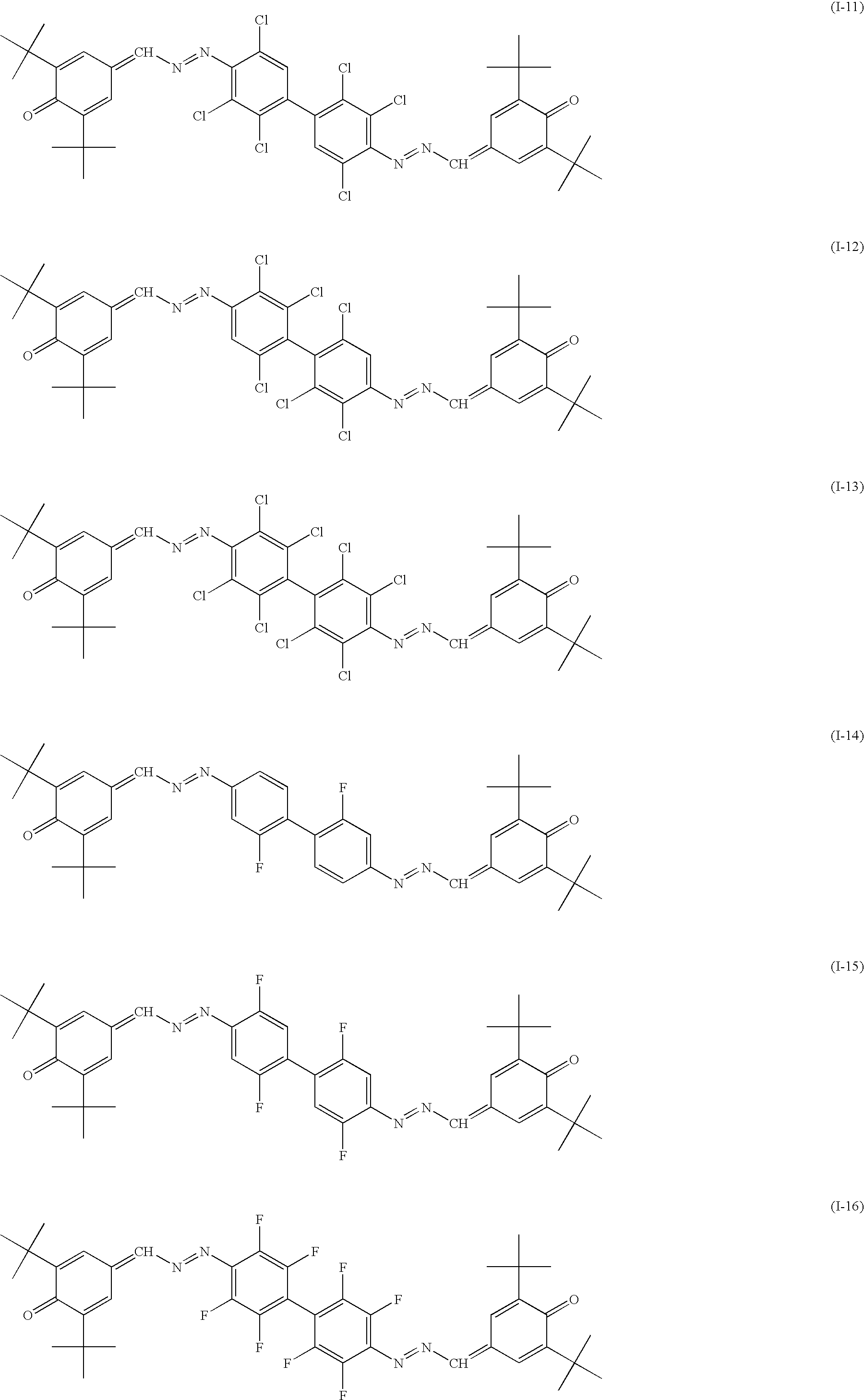

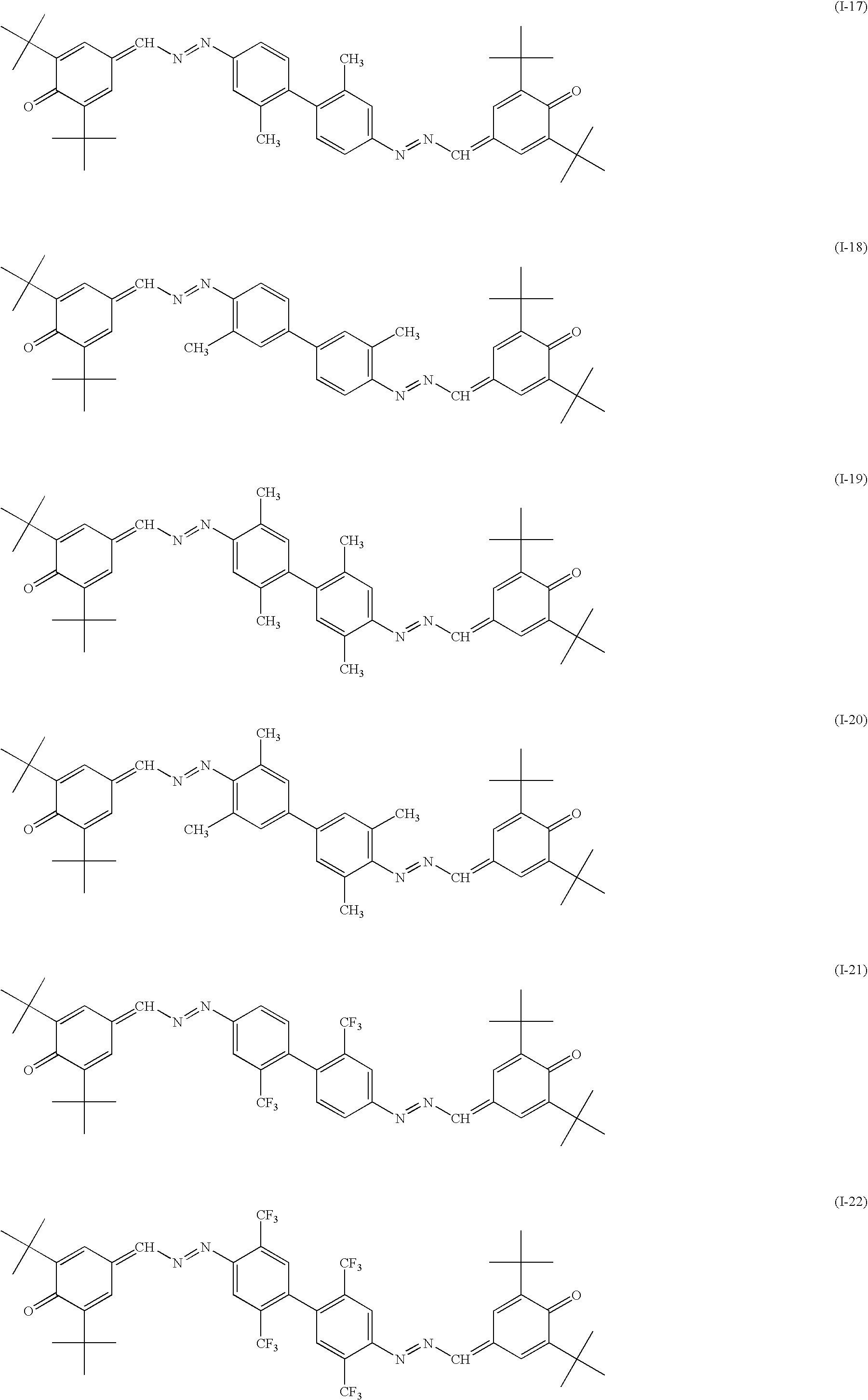

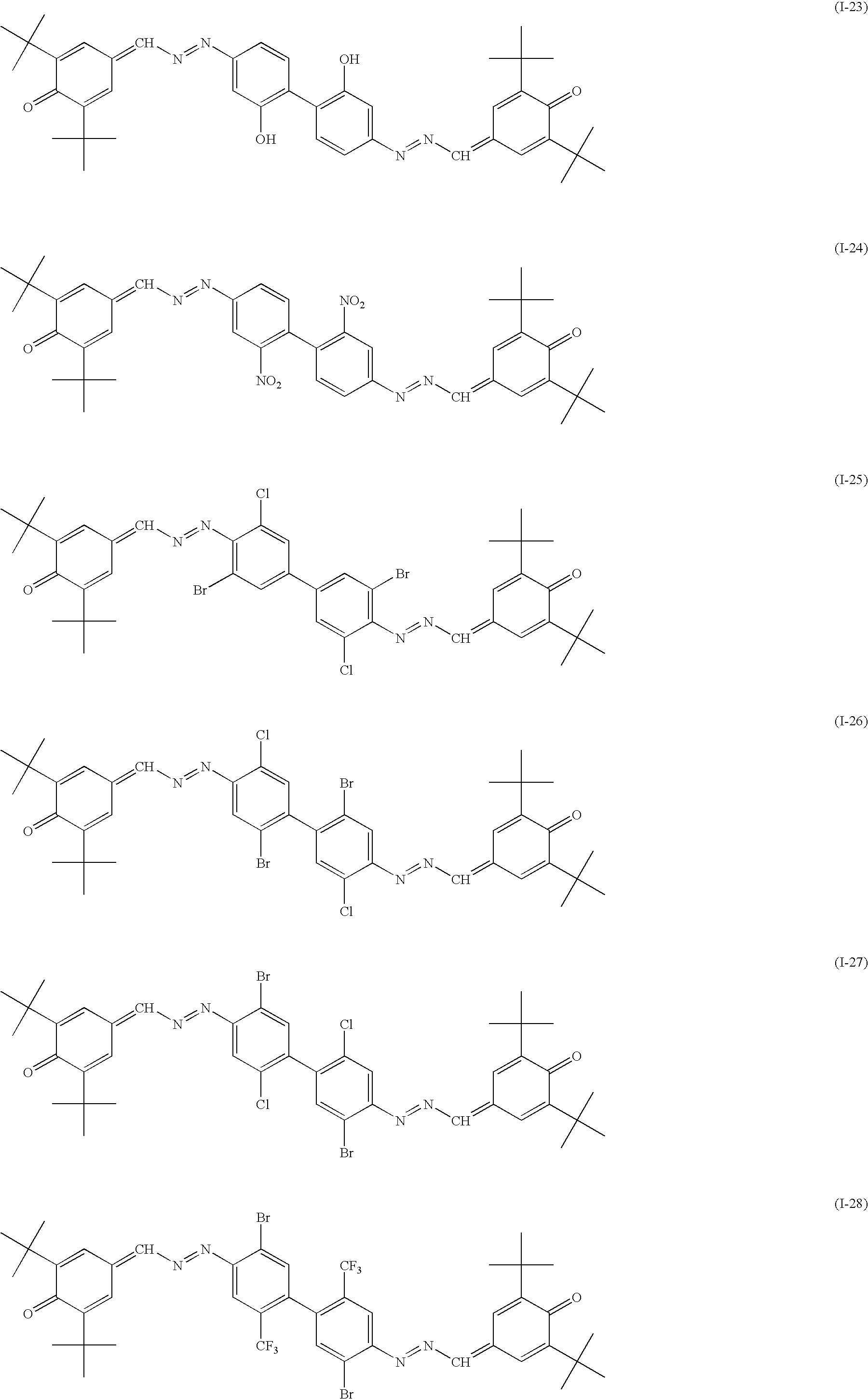

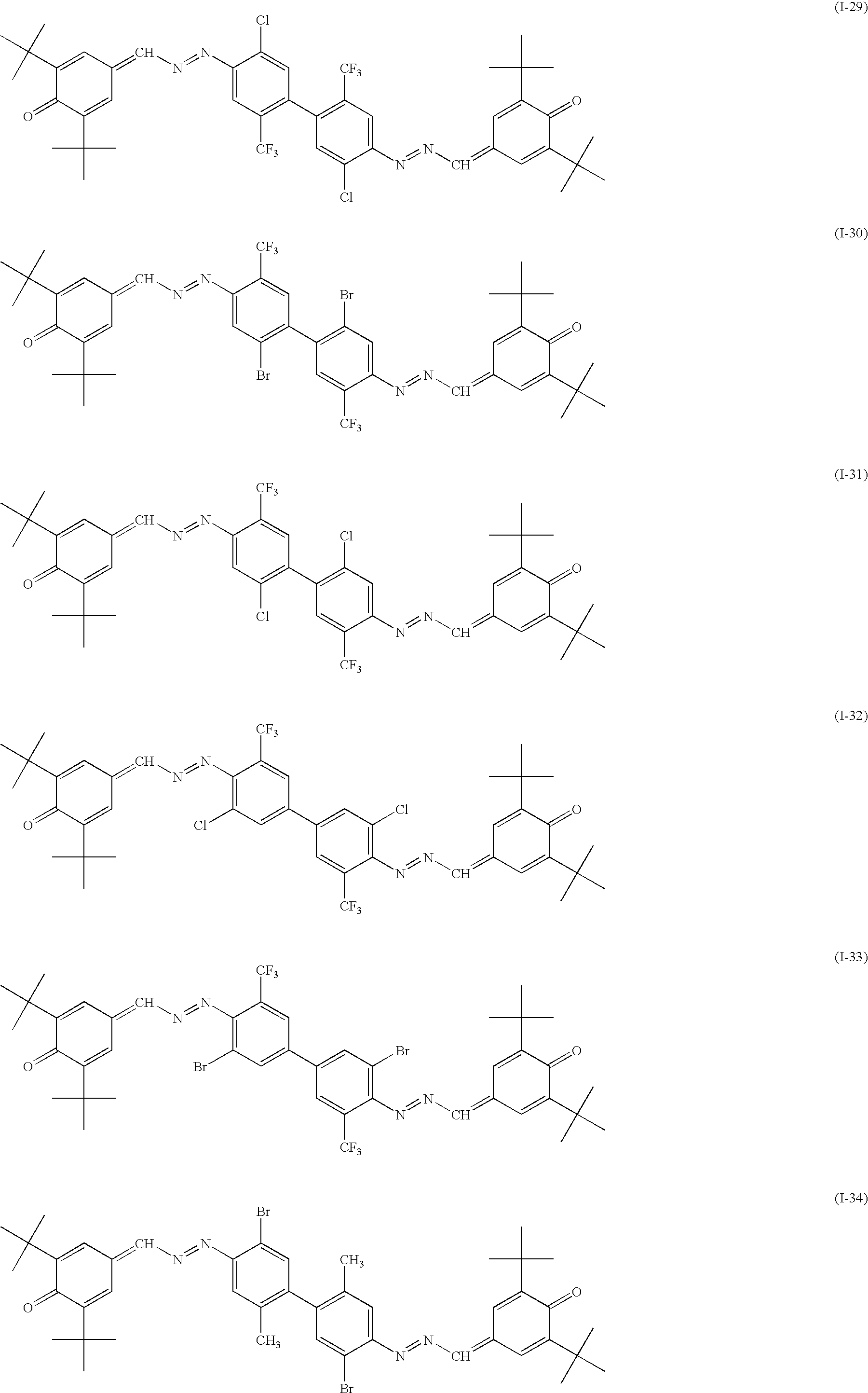

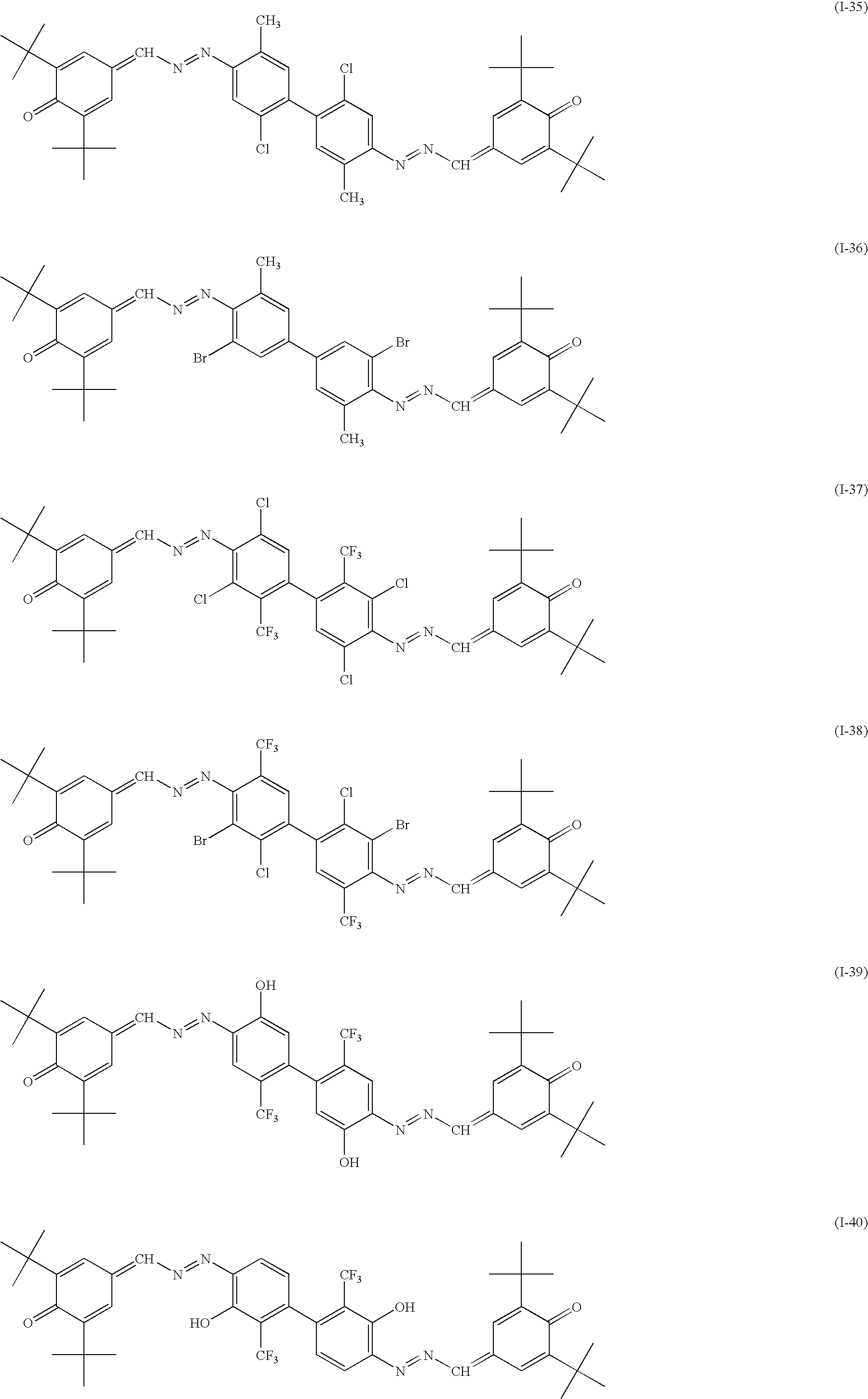

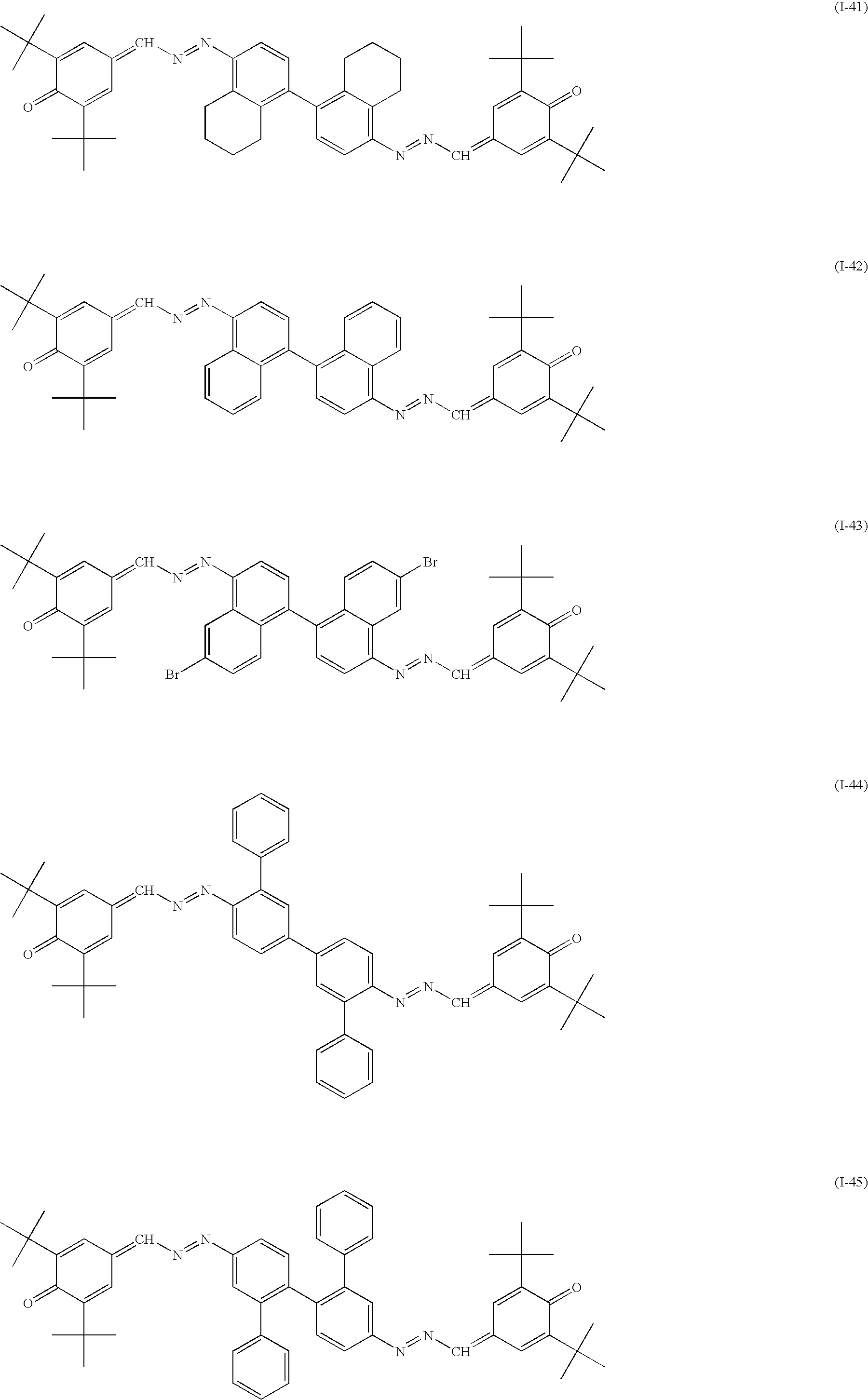

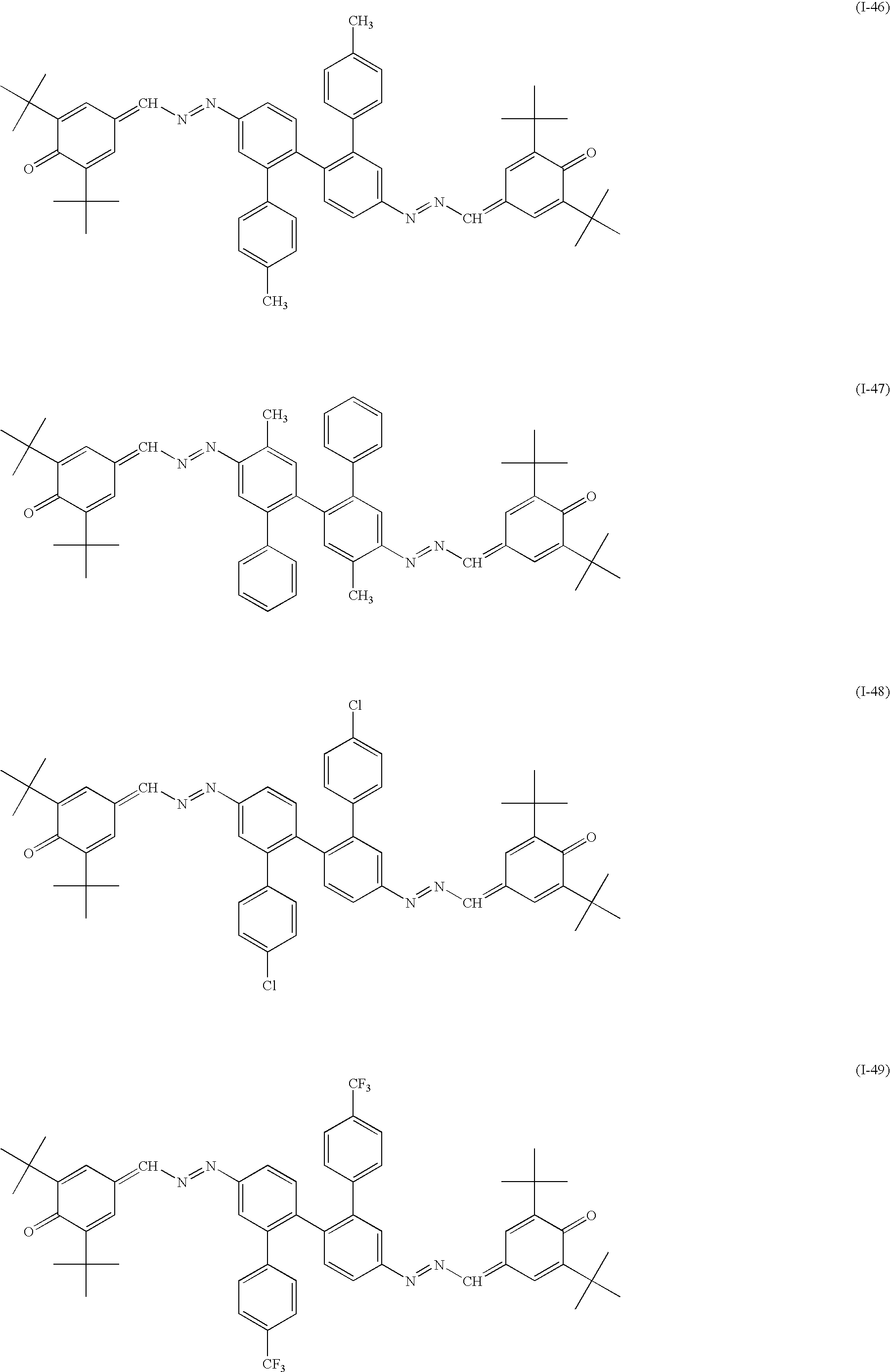

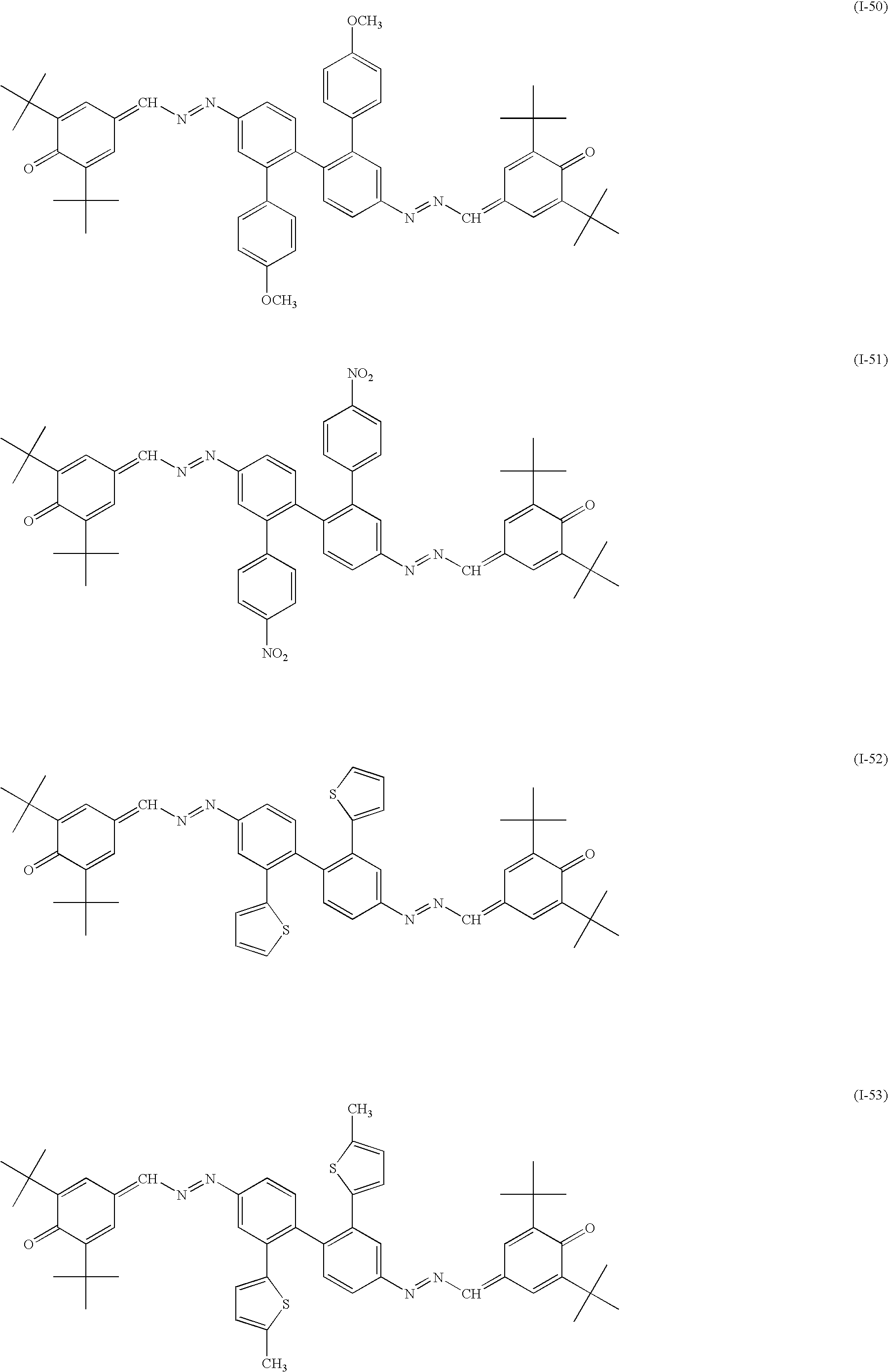

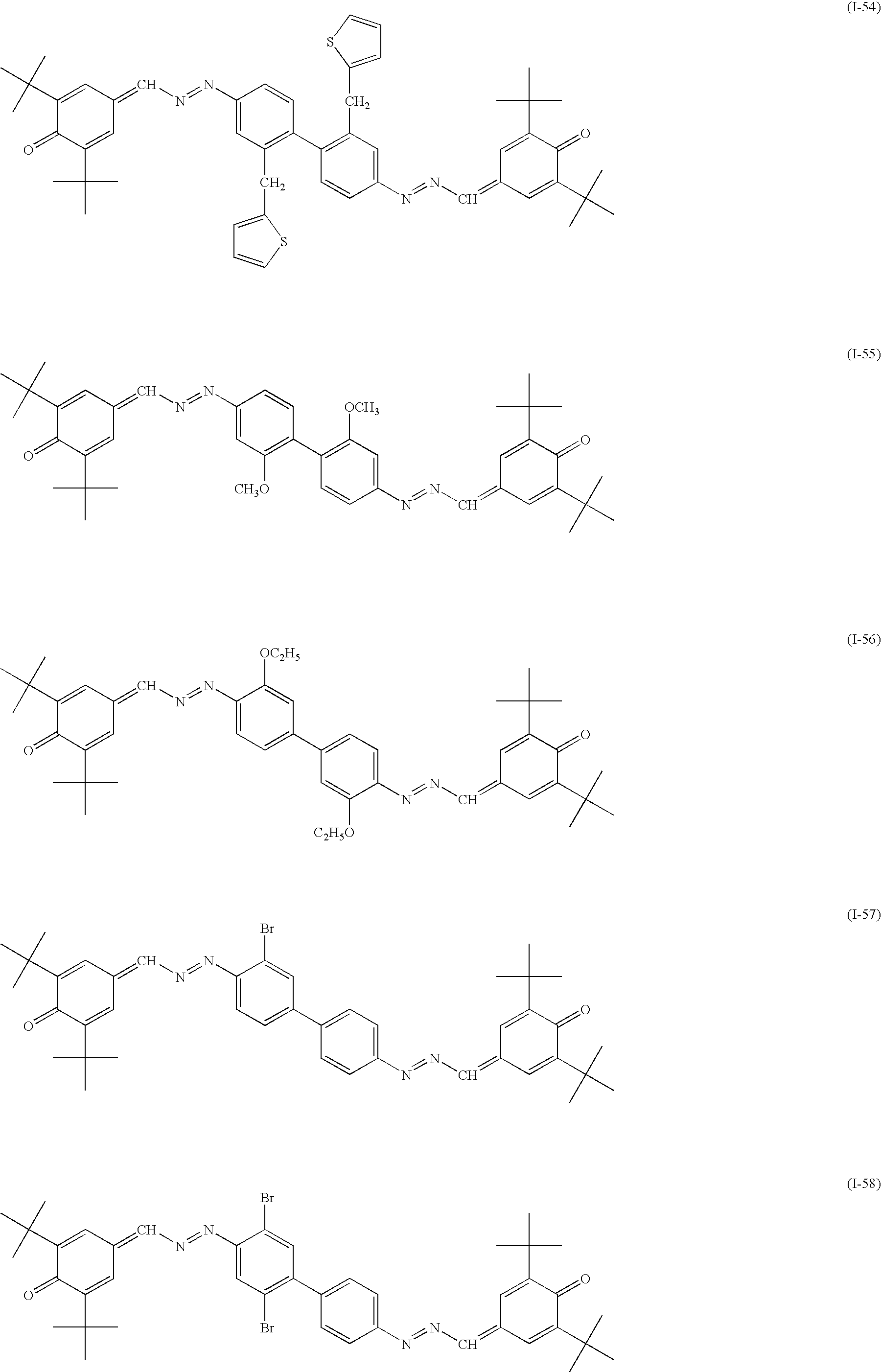

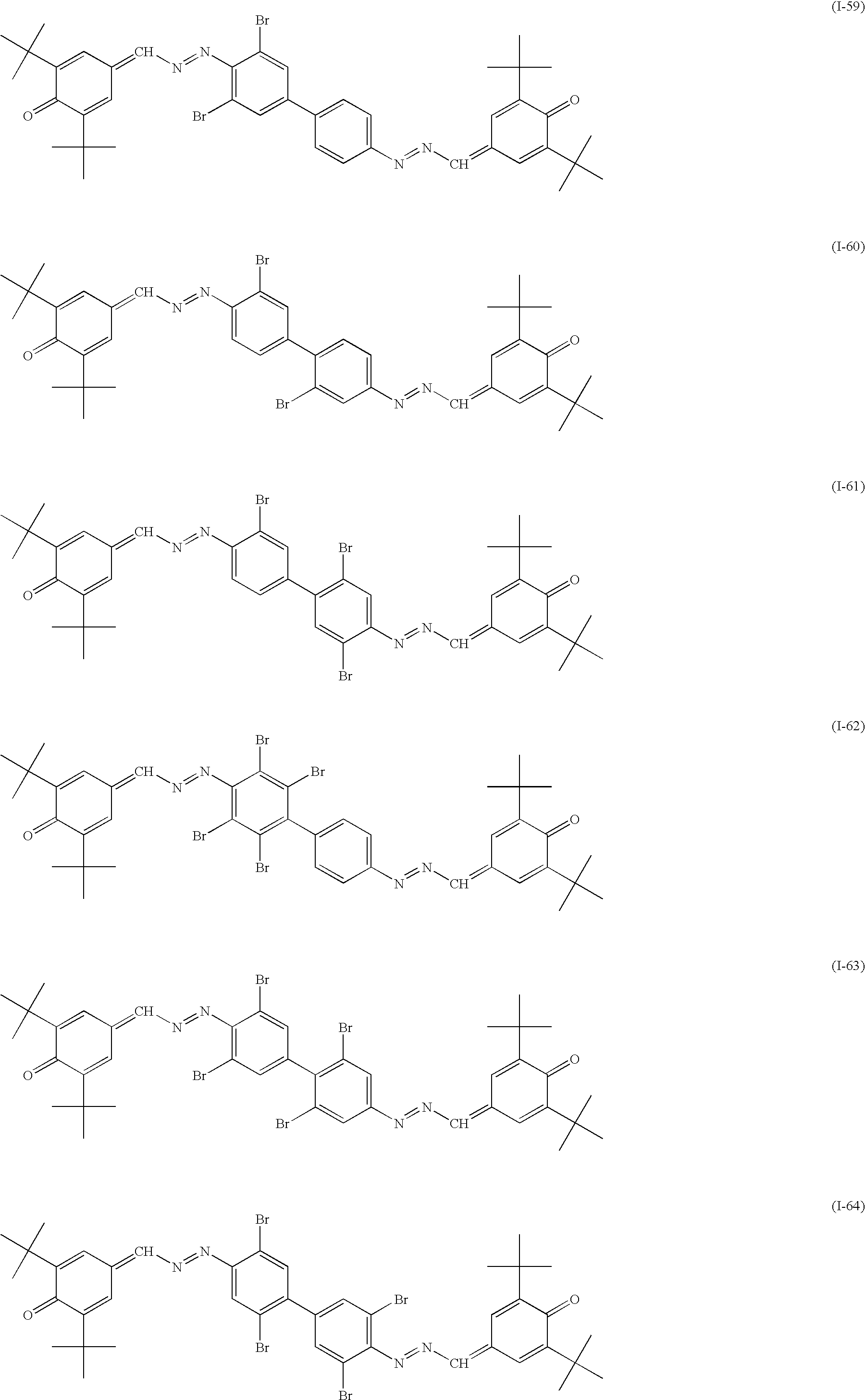

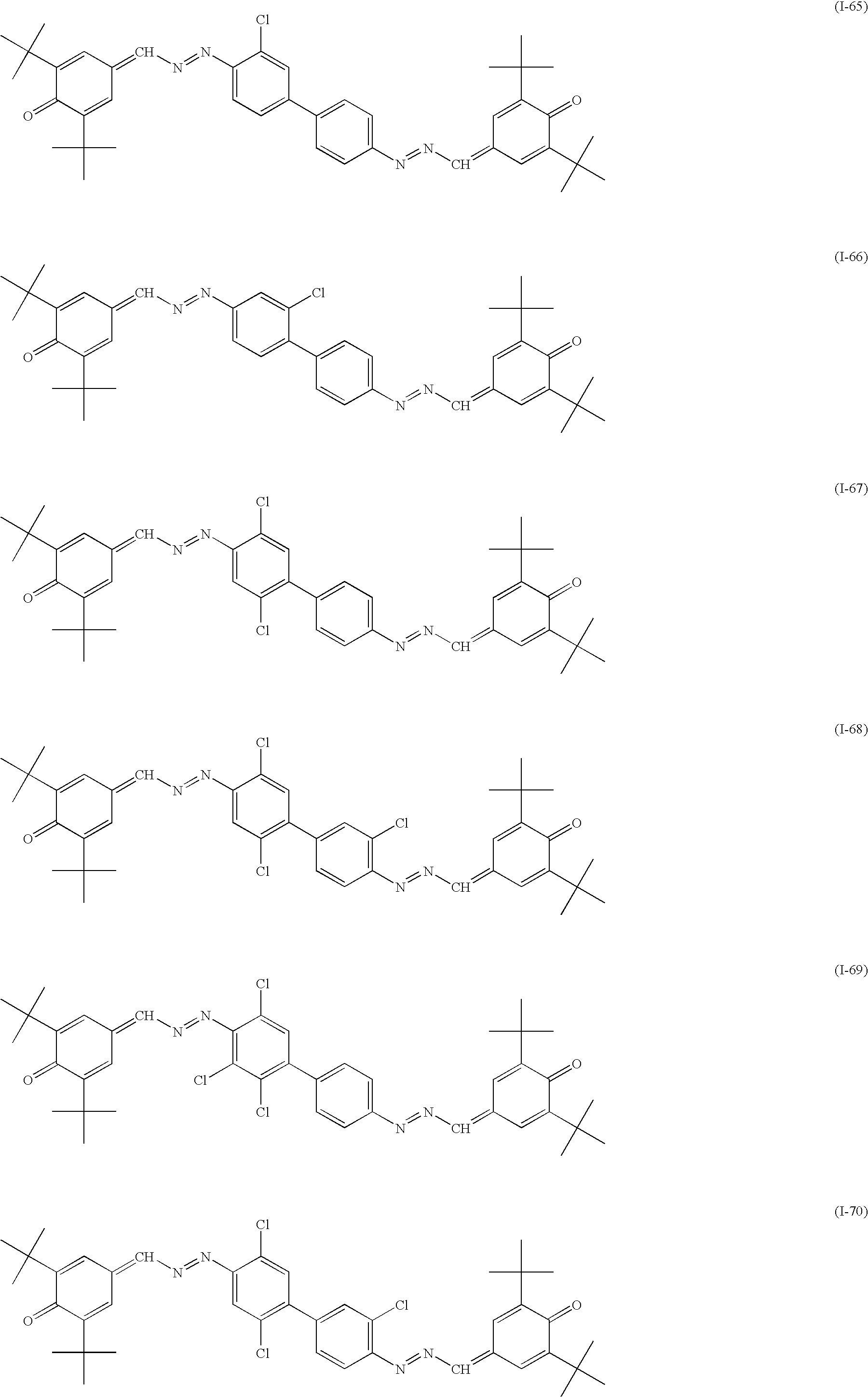

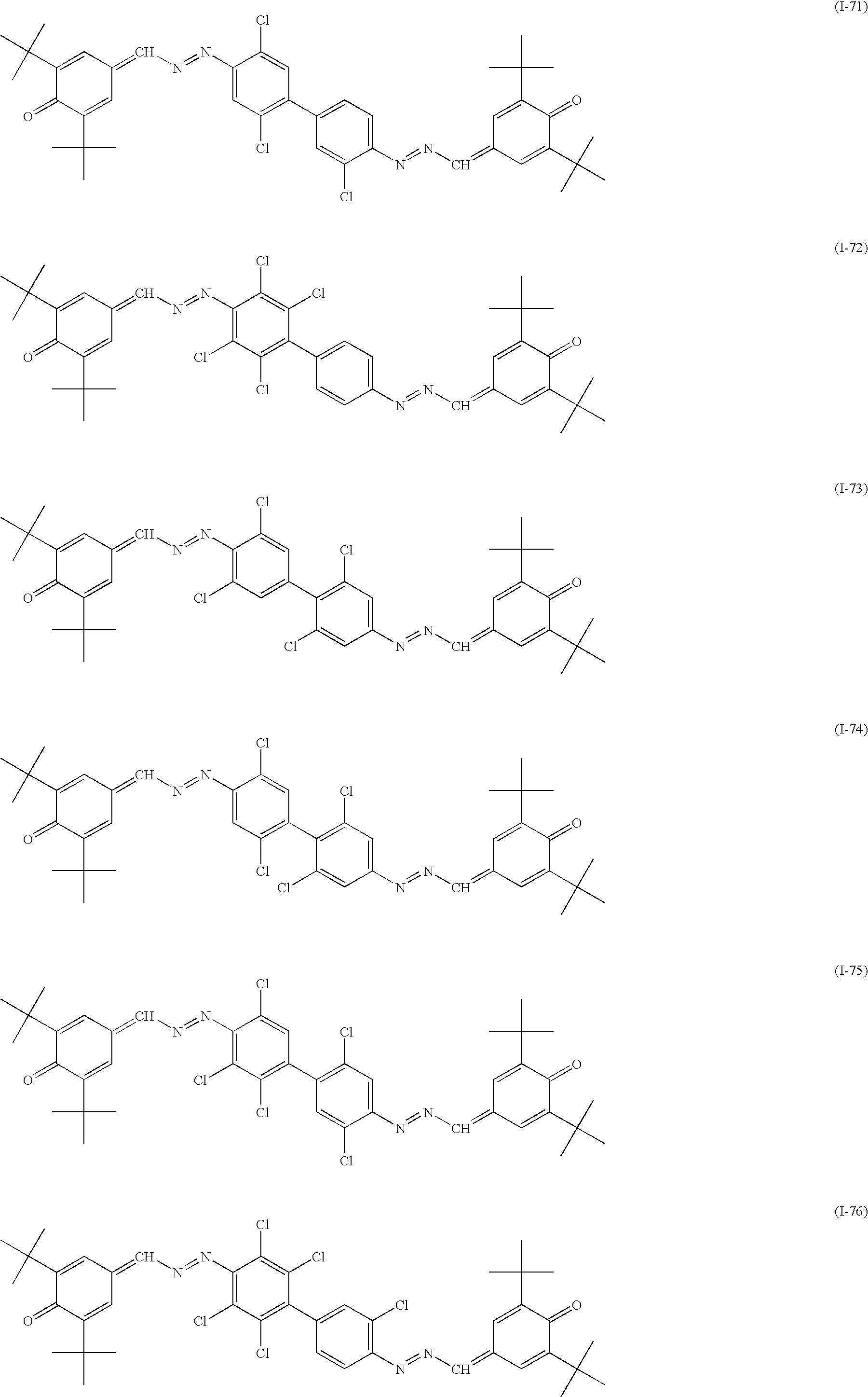

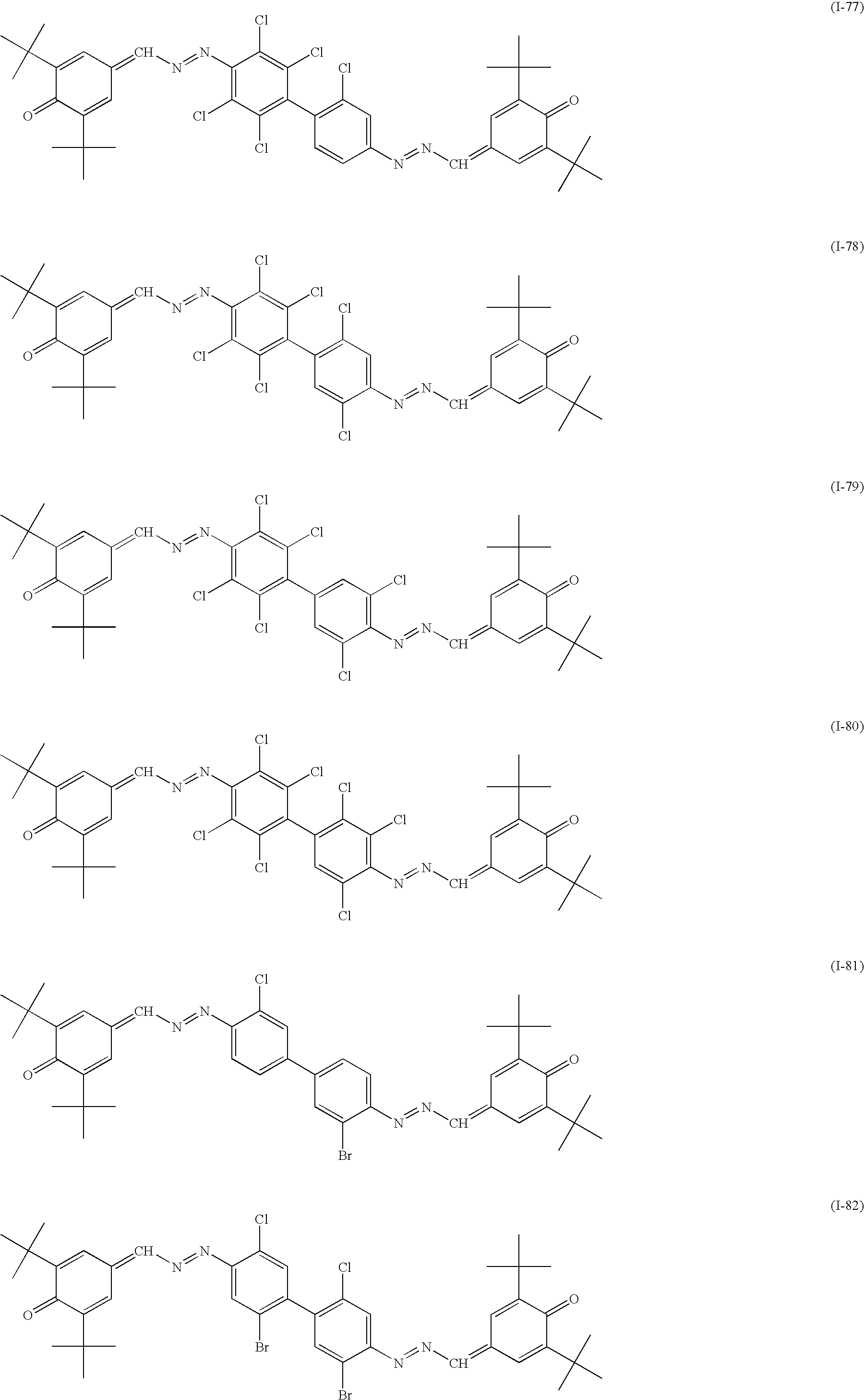

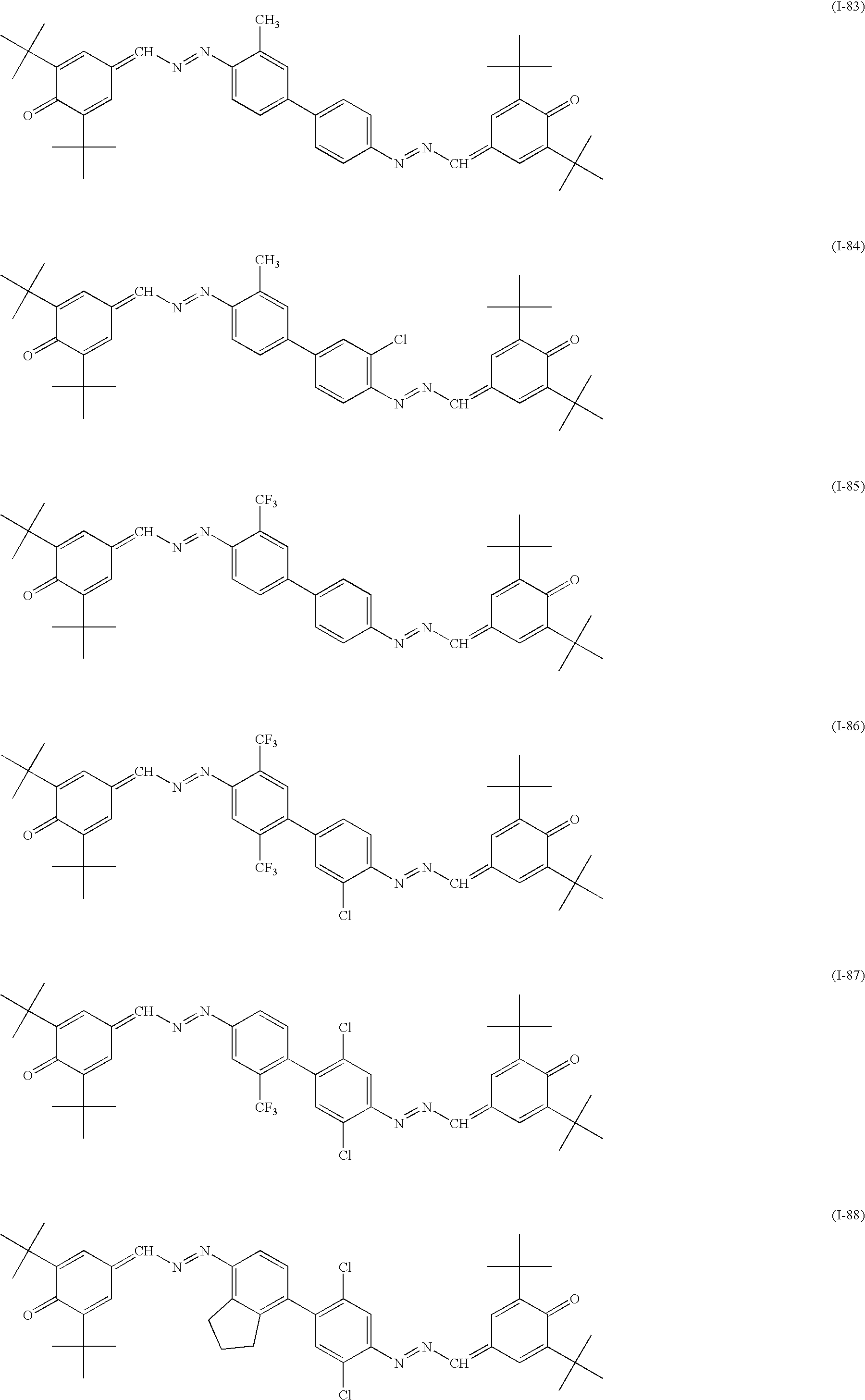

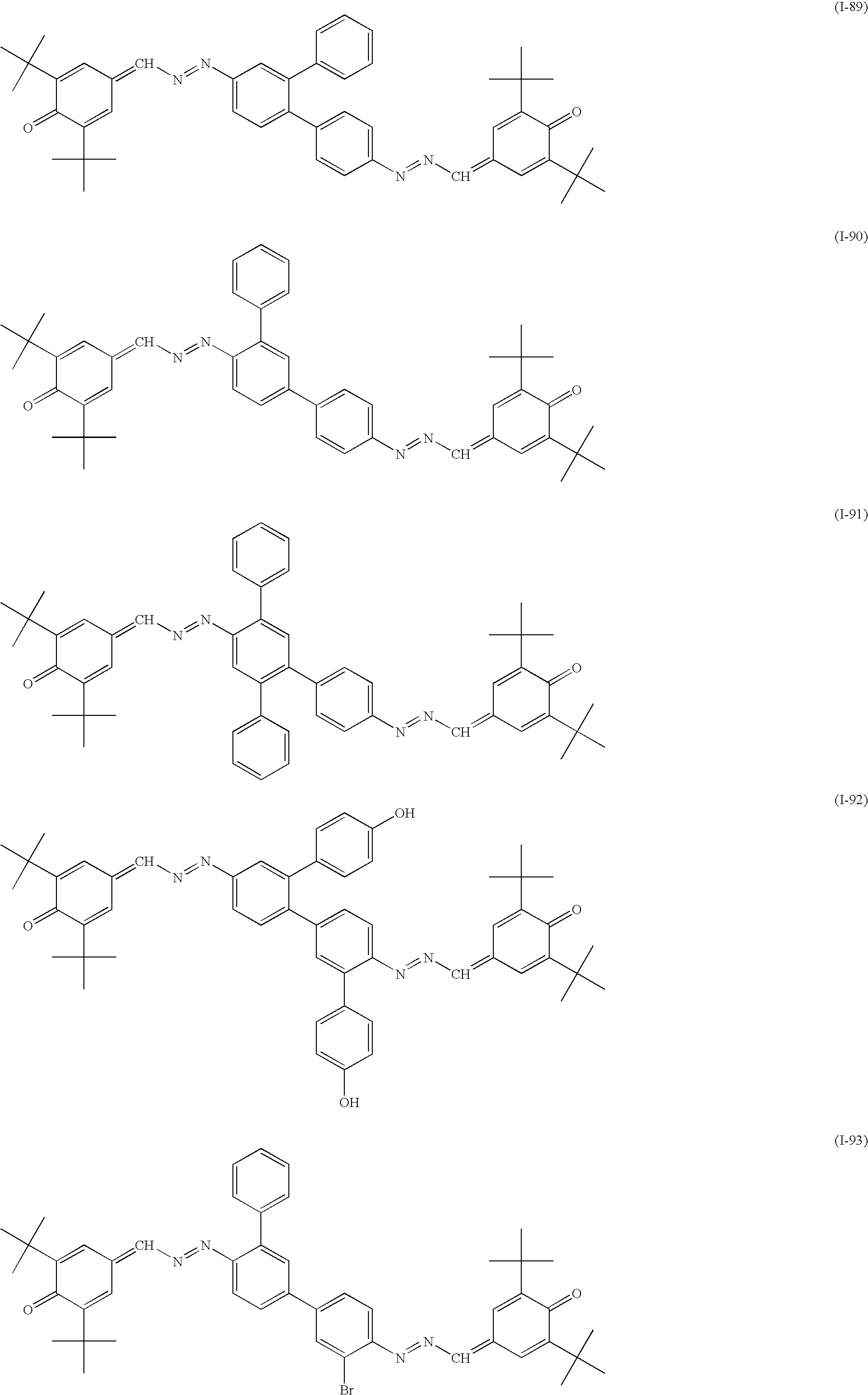

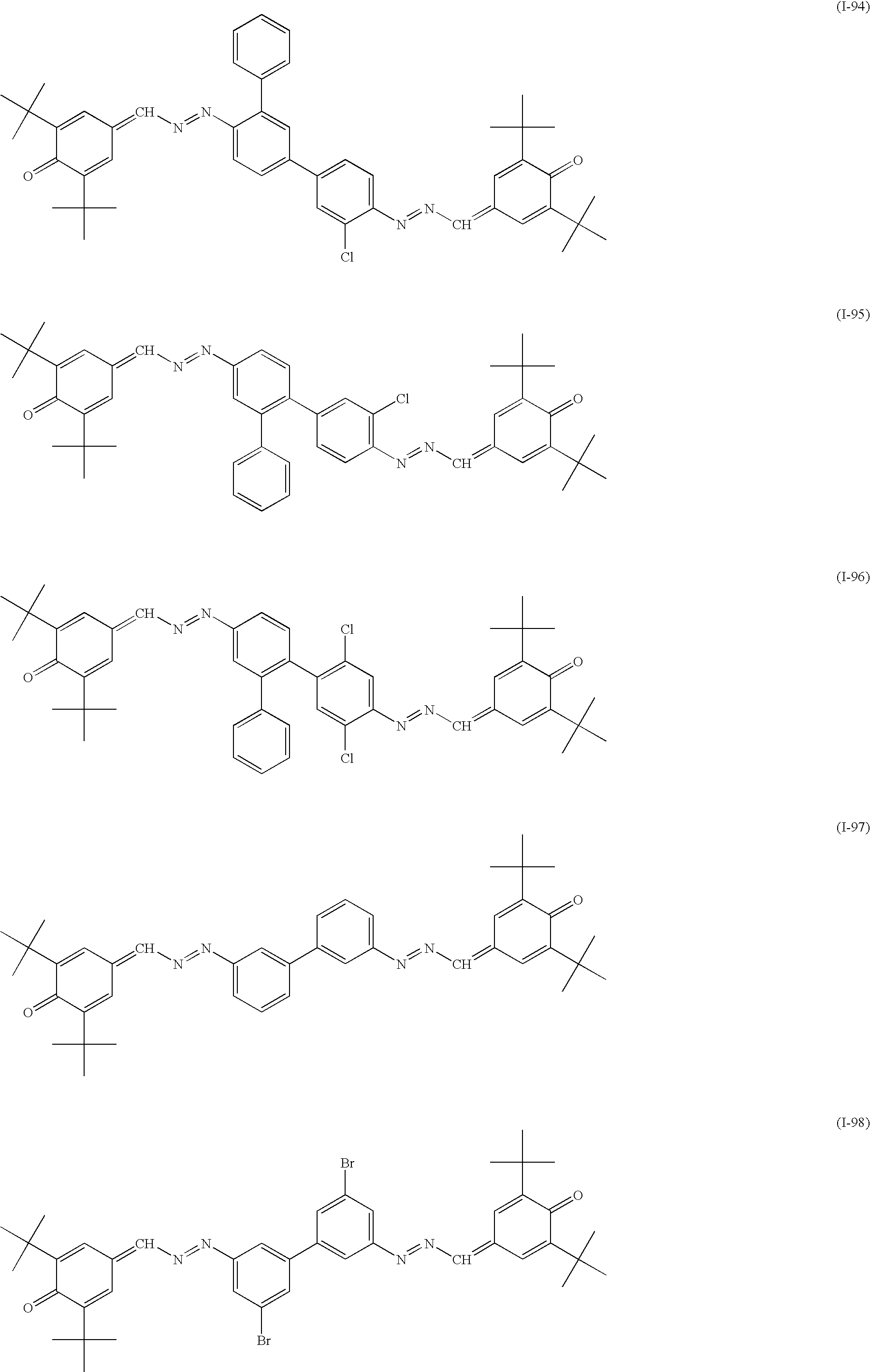

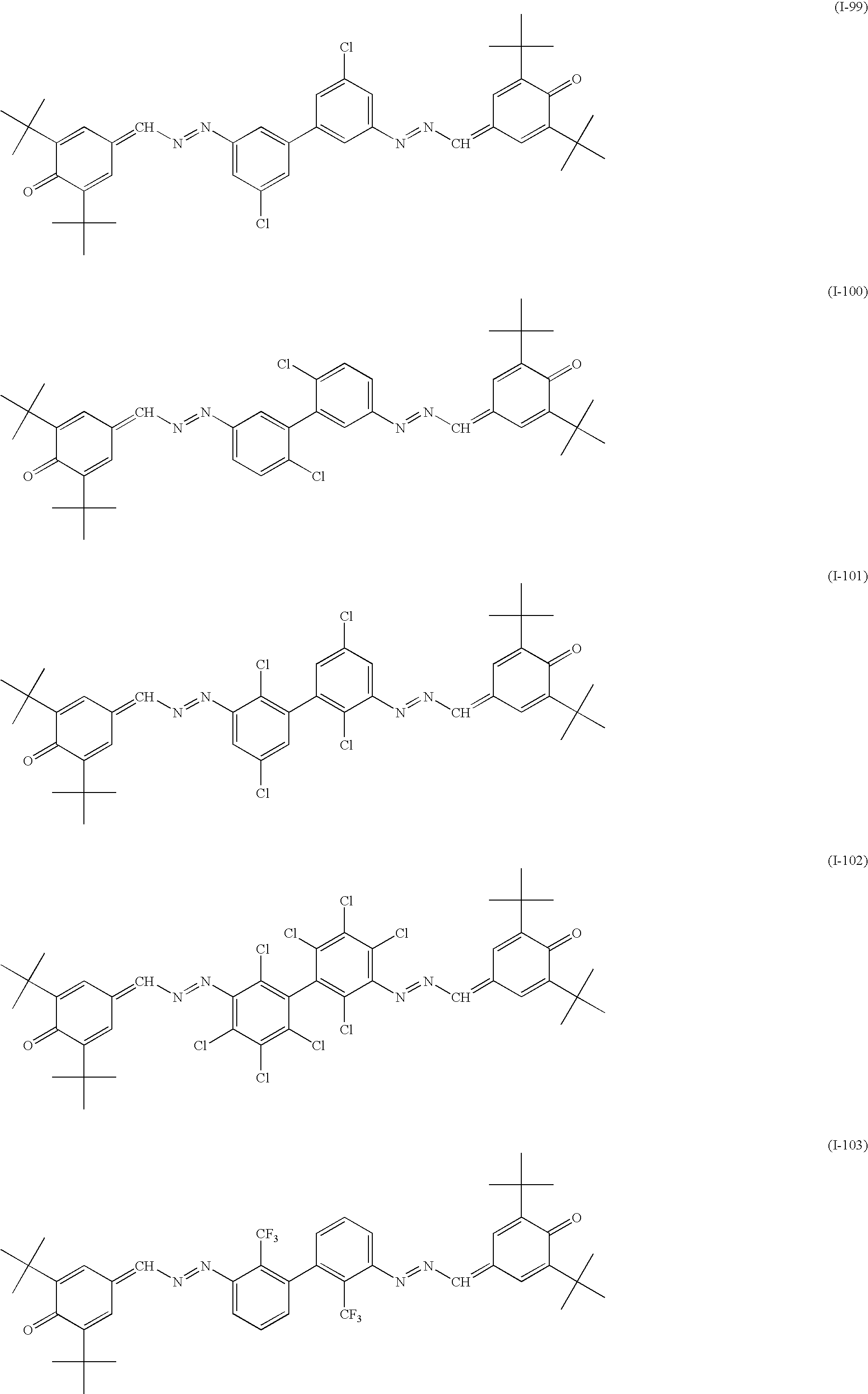

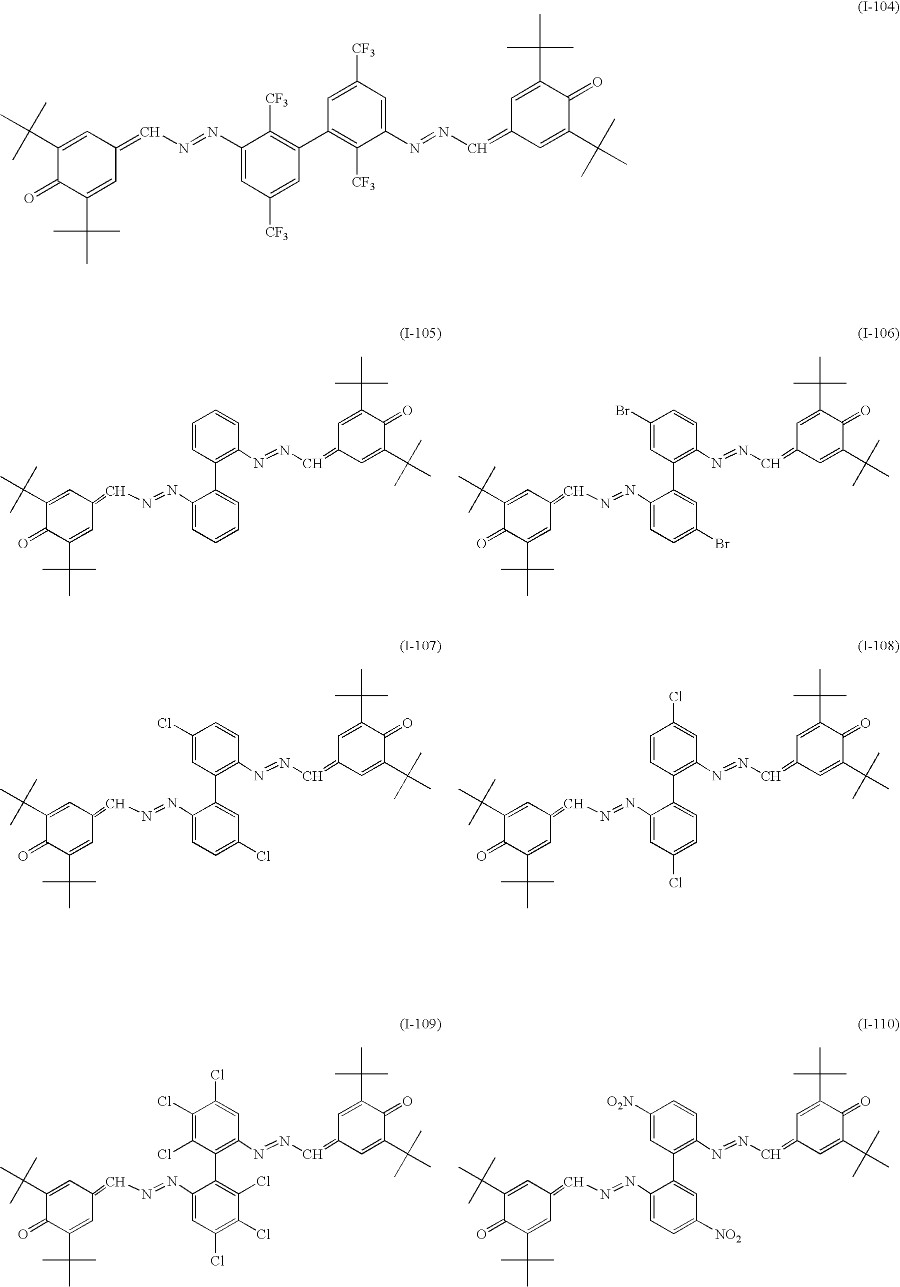

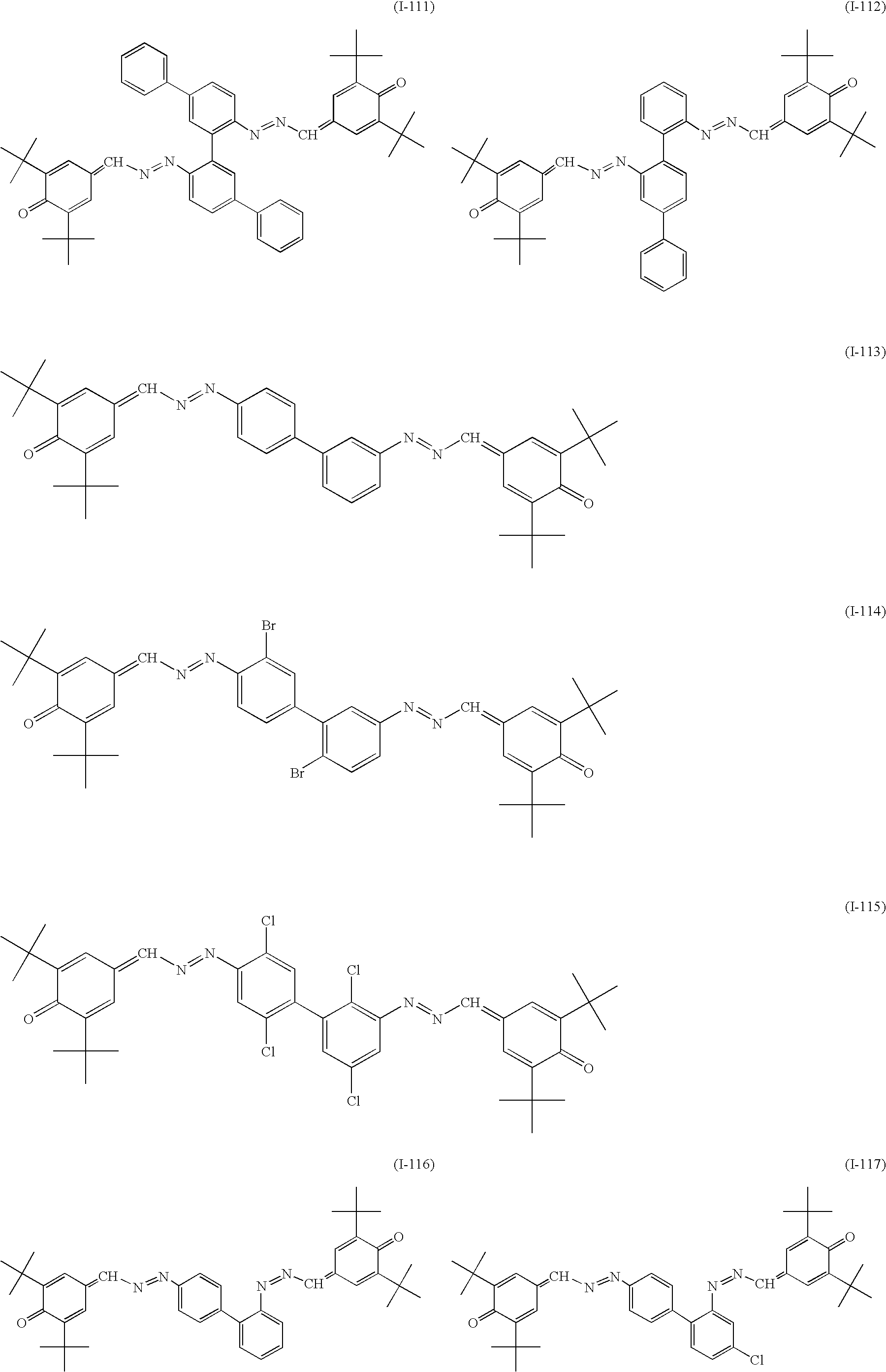

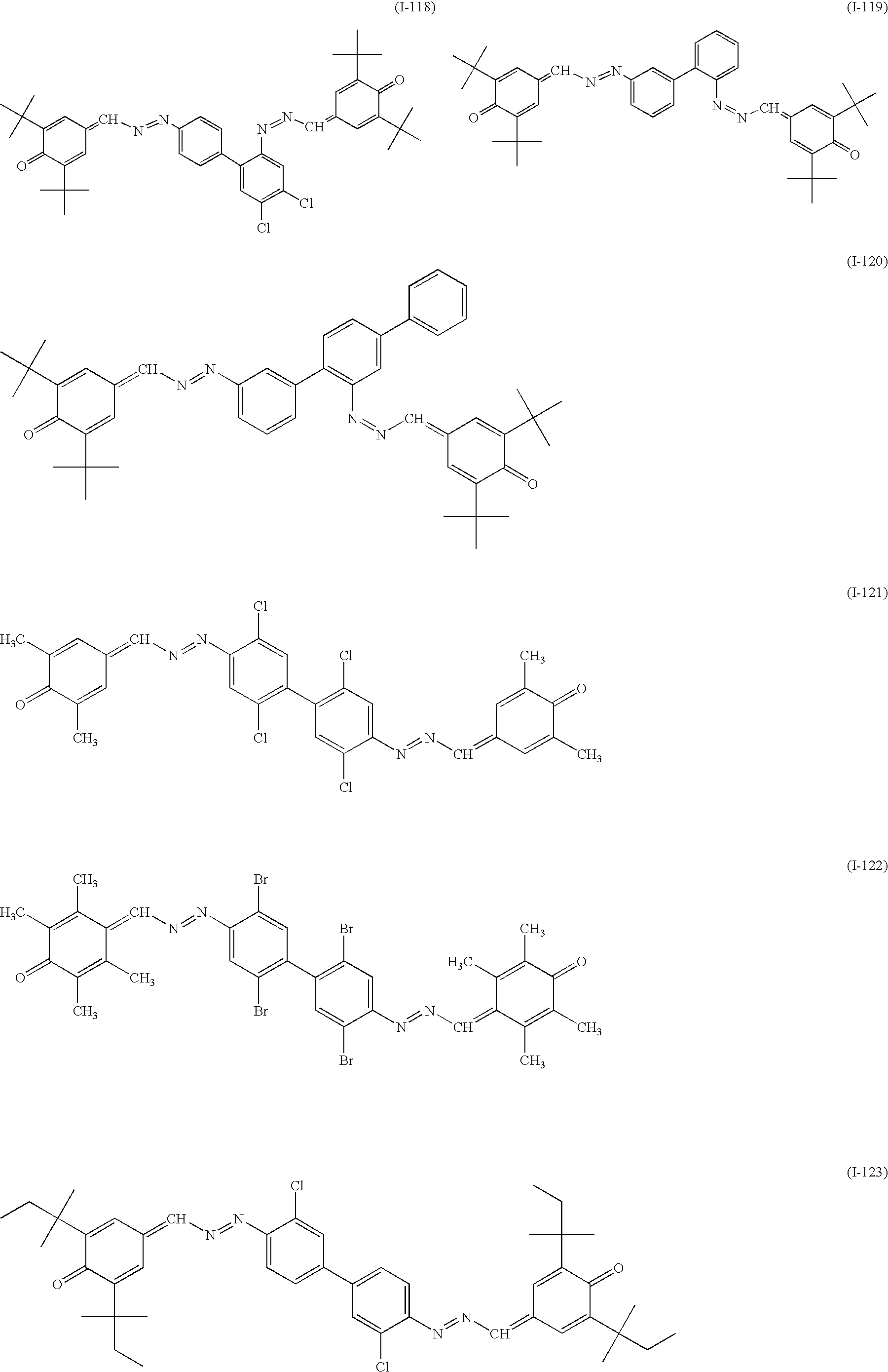

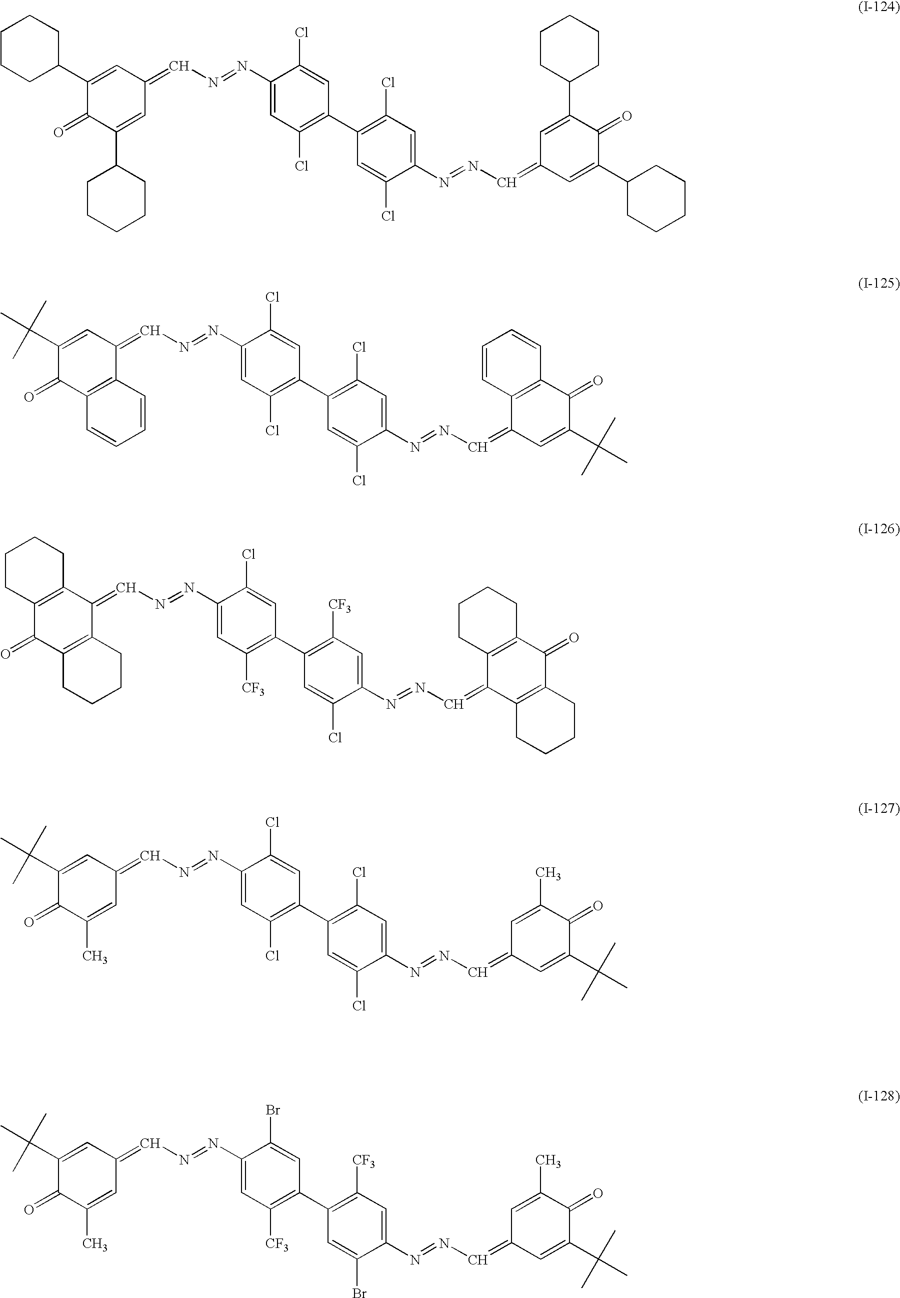

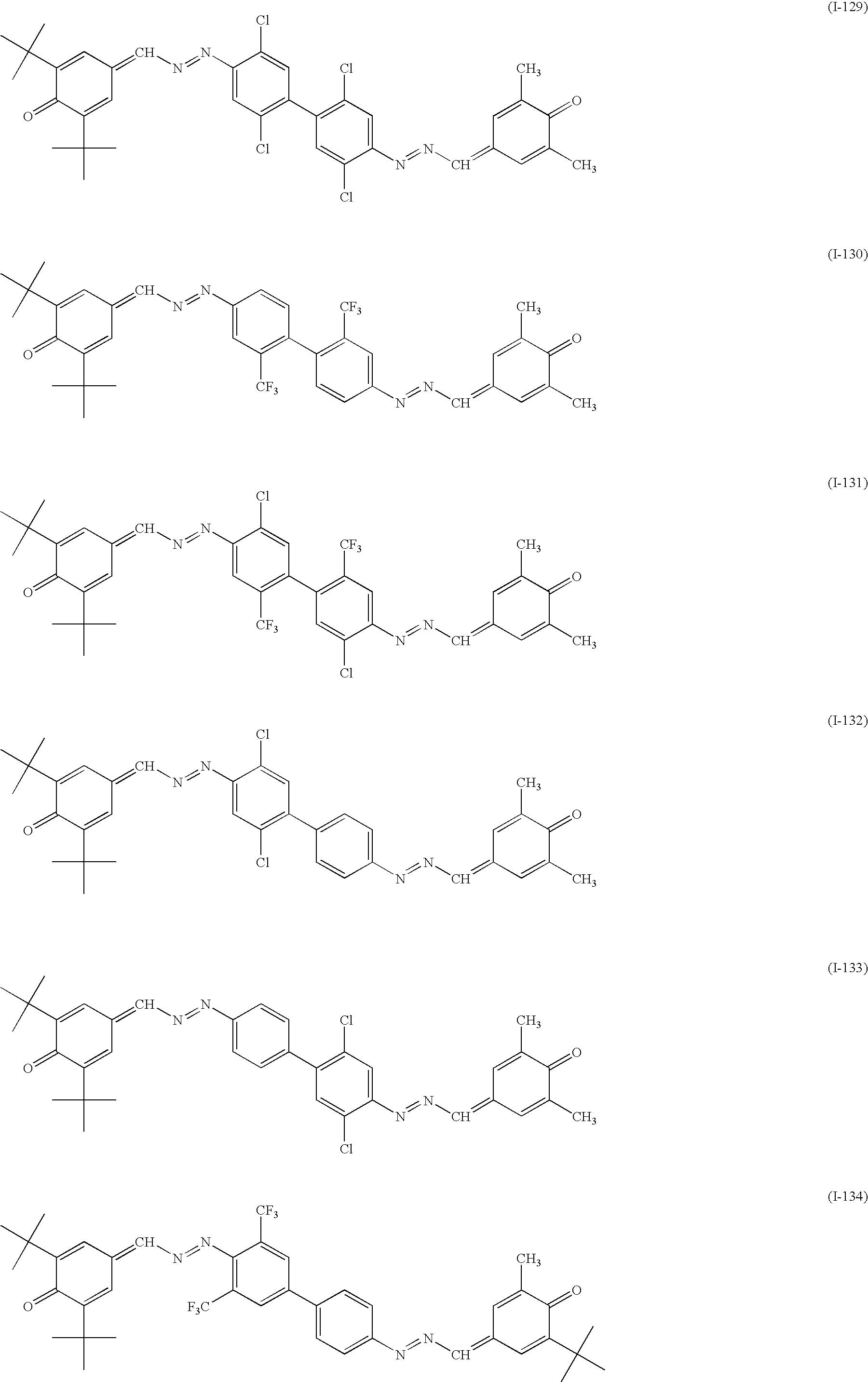

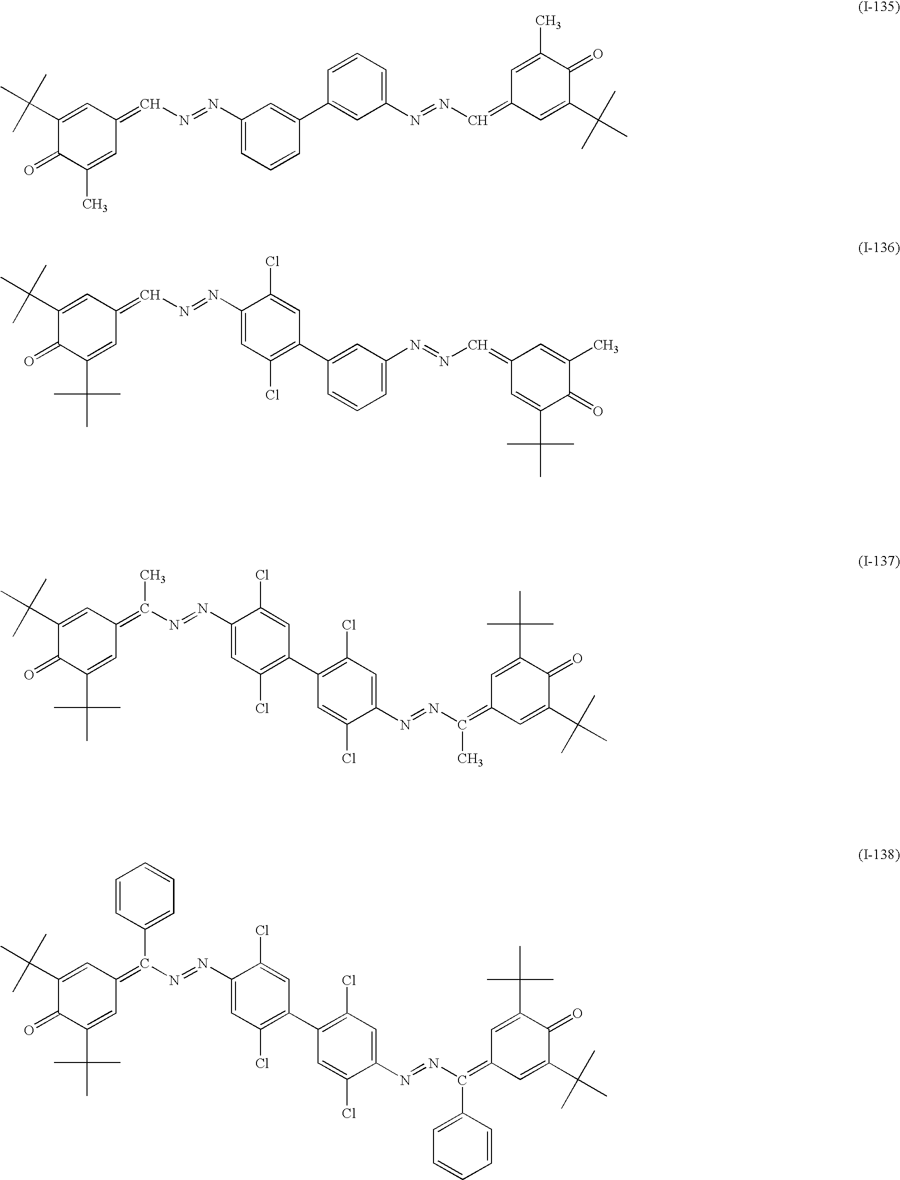

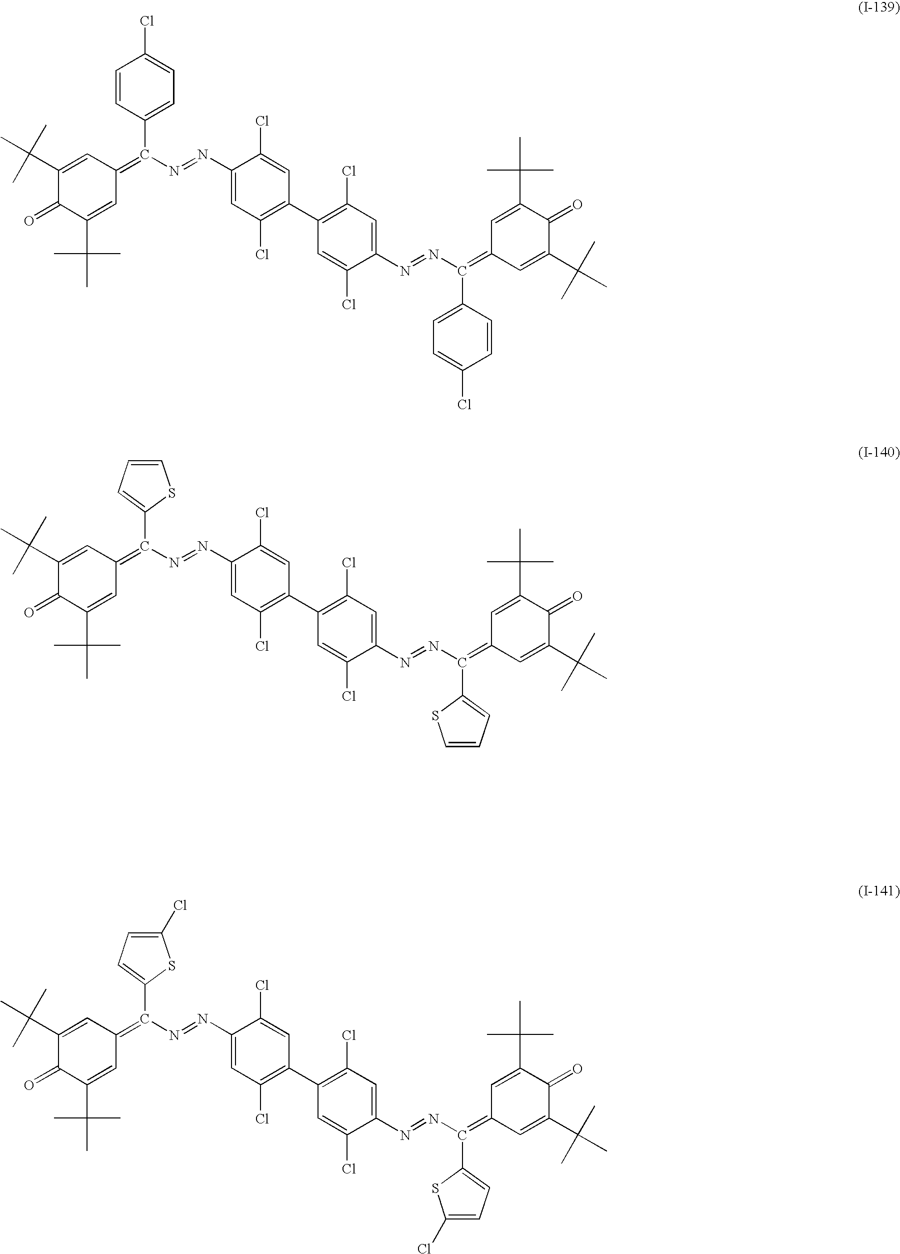

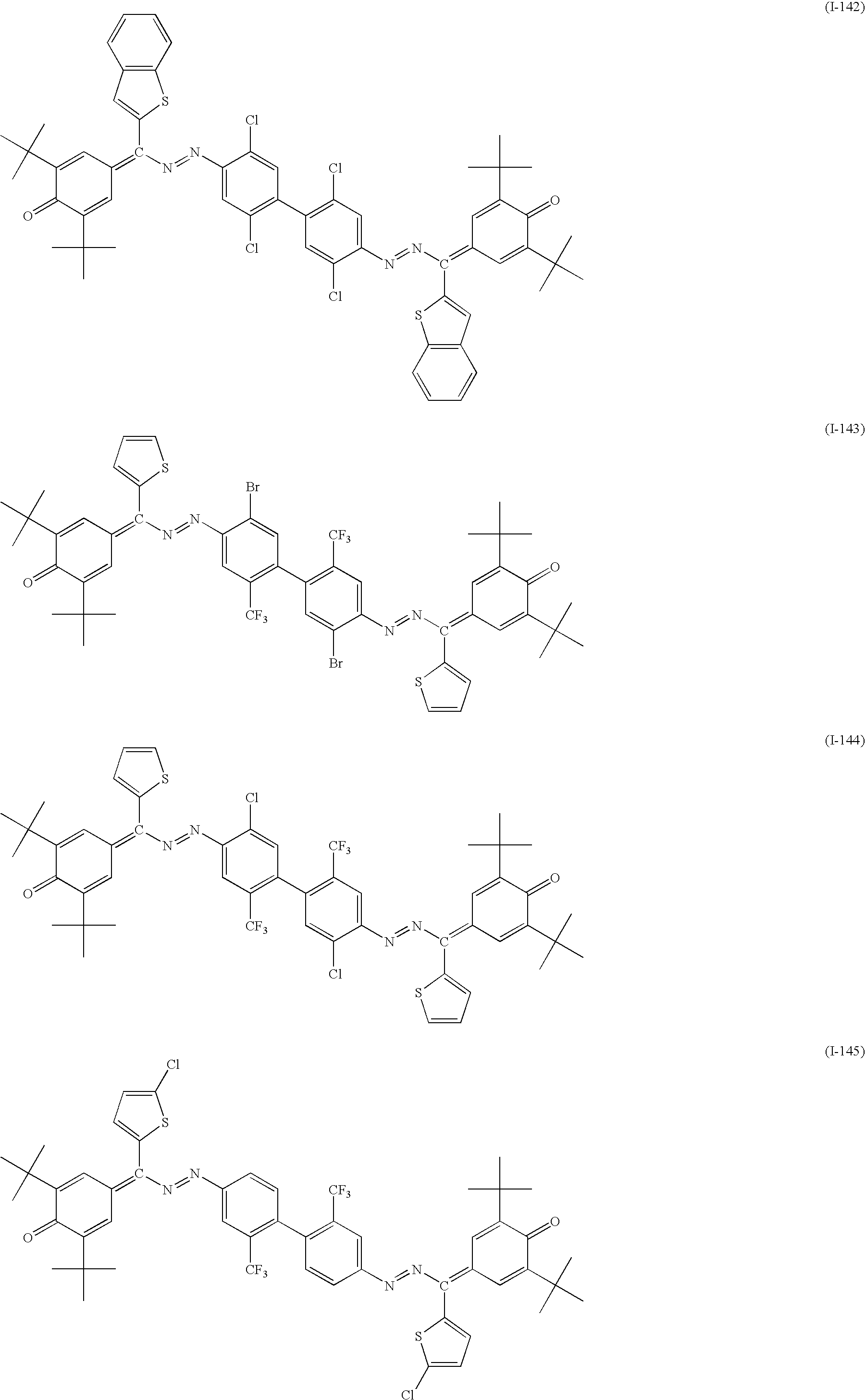

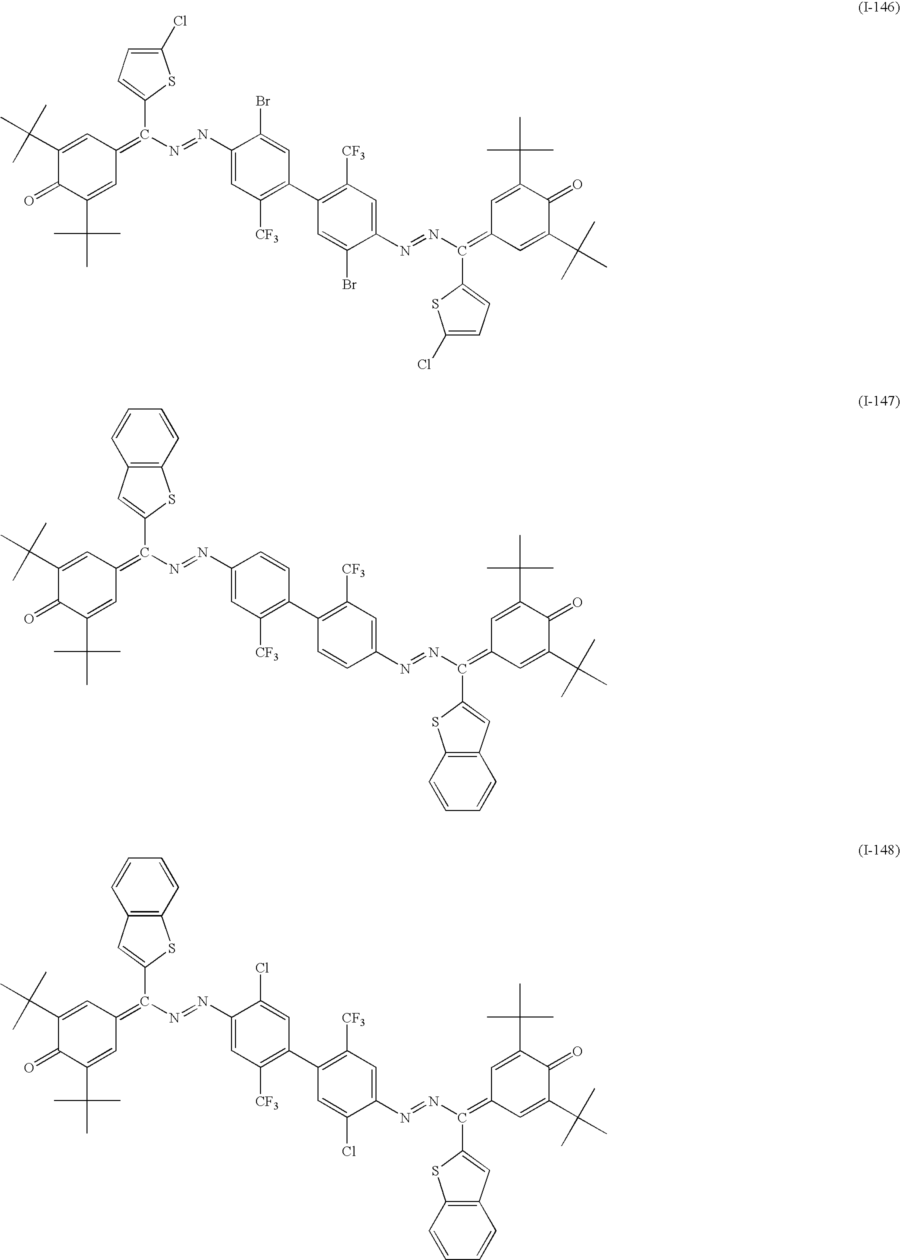

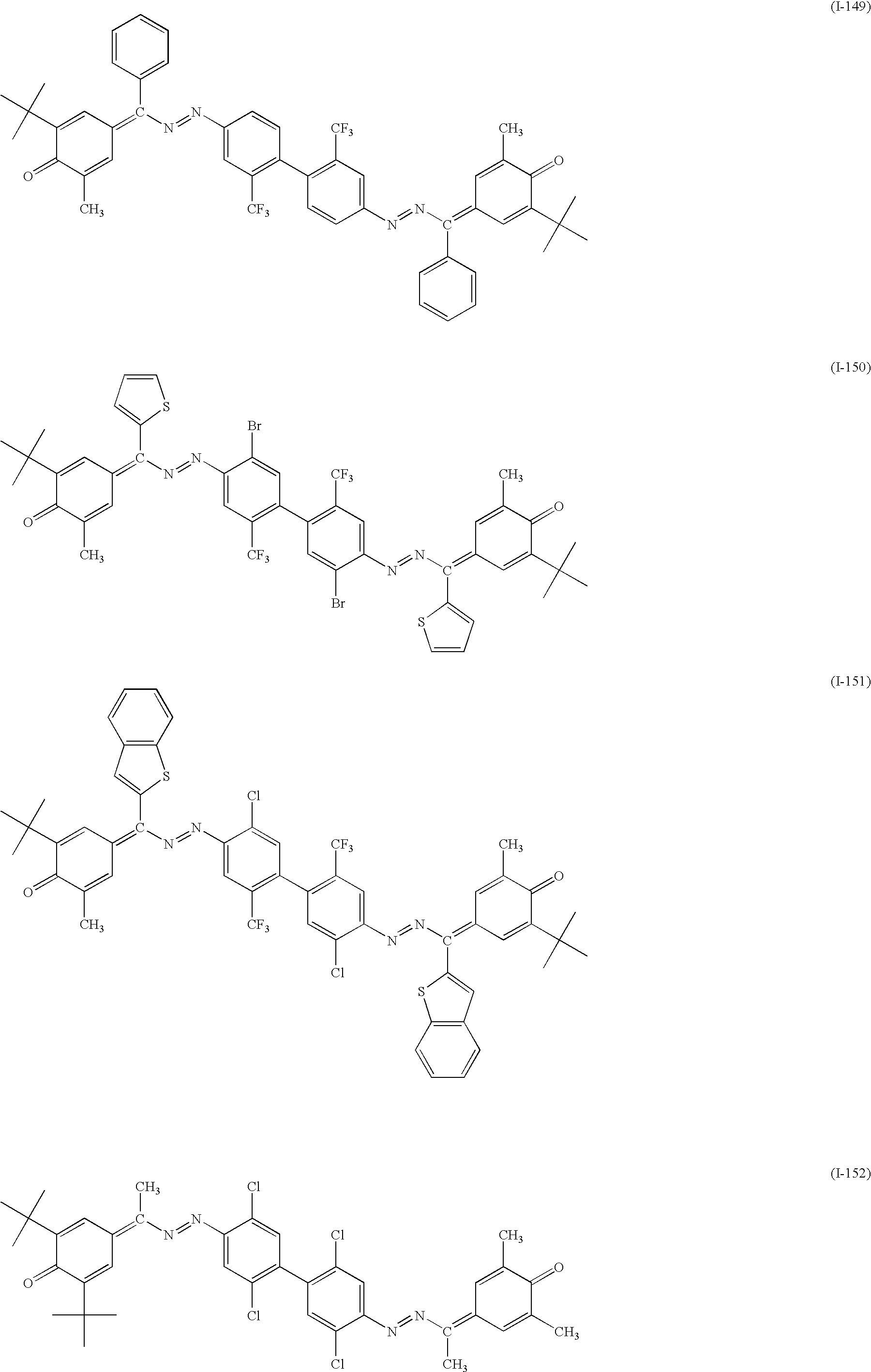

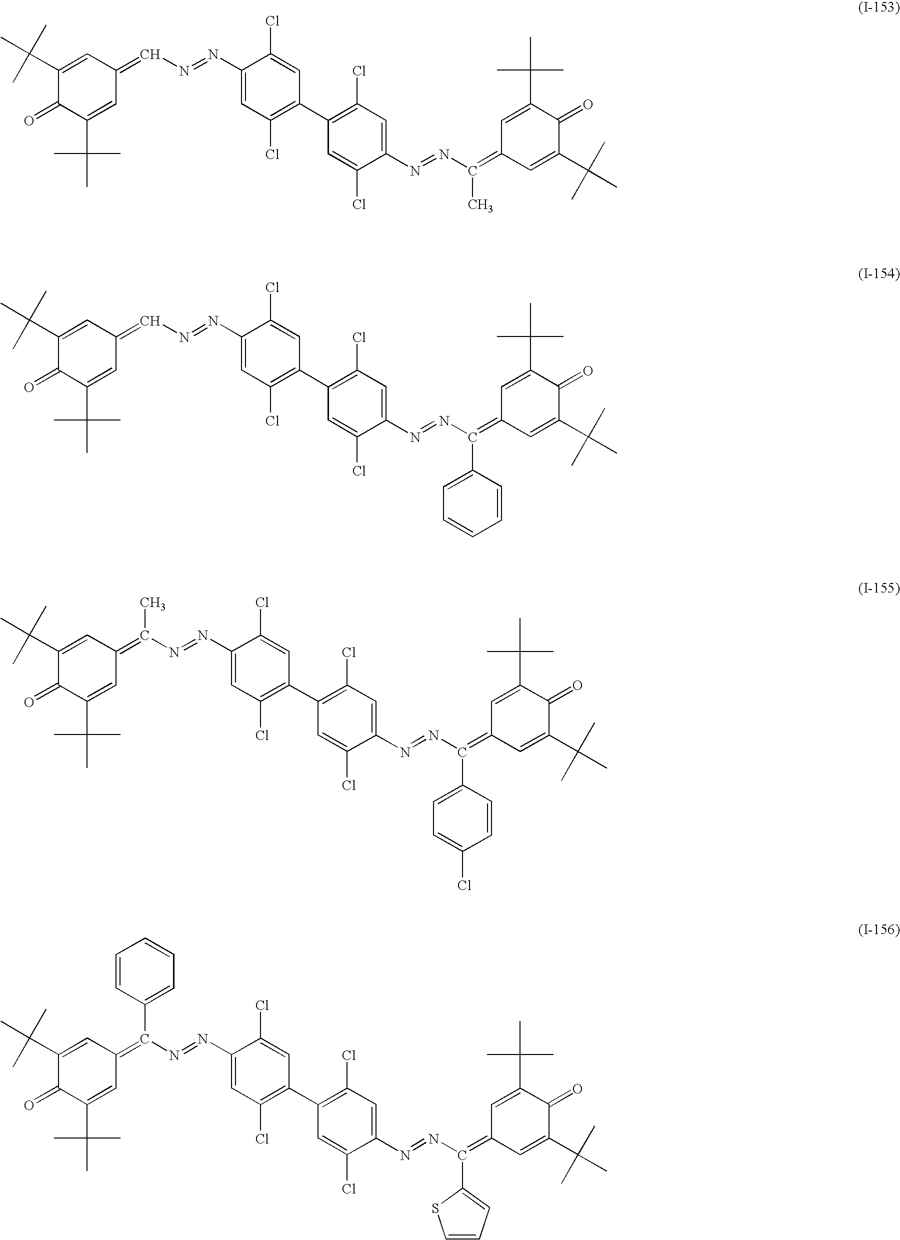

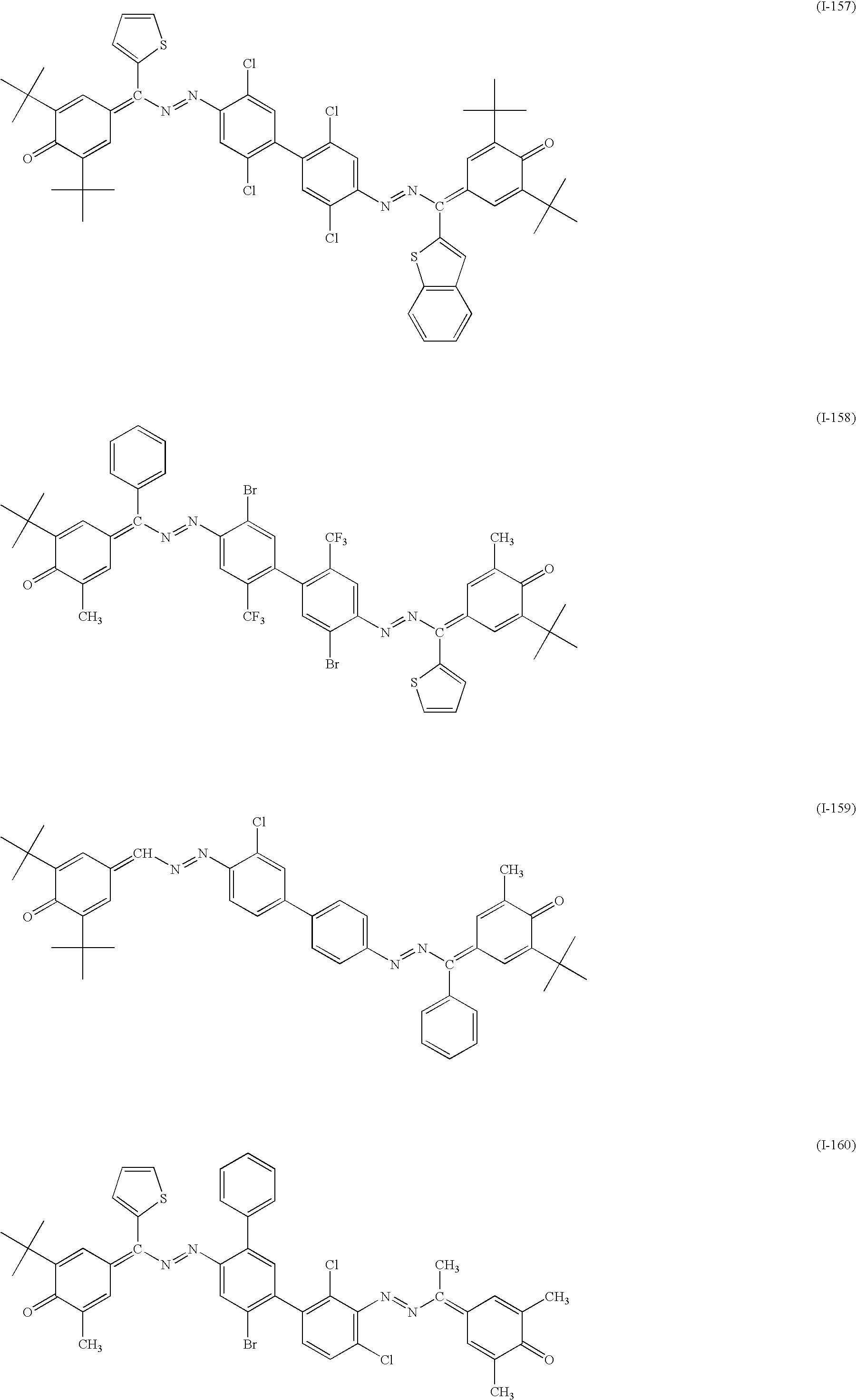

The quinone compounds of the present invention represented by the formula (I) can be produced, for example, by a method shown by the following scheme 1. Furthermore, in the following formulas, R¹ to R¹² are the same as previously defined.

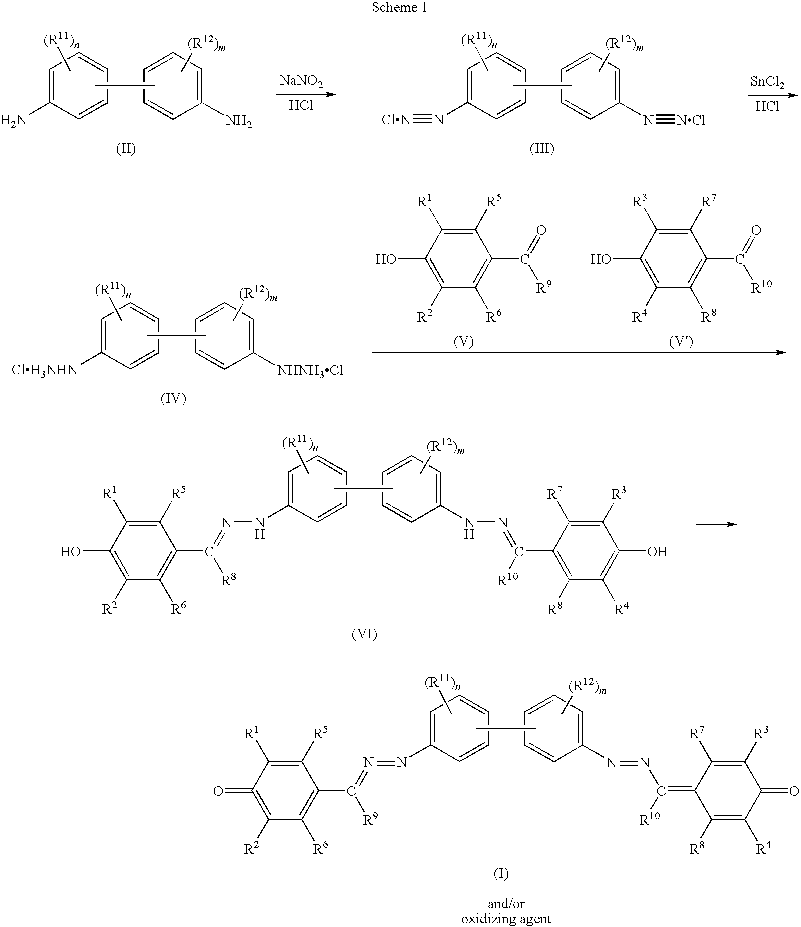

Namely, after first converting a bisaniline (II) to a bisdiazonium salt (III) using sodium nitrite in hydrochloric acid, a bishydrazine salt (IV) is obtained using a reducing agent such as stannous chloride, sodium sulfite or potassium sulfite. The resulting bishydrazine salt (IV) and carbonyl compound represented by structural formula (V) and/or (V′) are condensed using a base such as pyridine, triethylamine or sodium acetate to prepare a bishydrazone represented by structural formula (VI). Finally, the target quinone (general formula (I)) can be synthesized by reacting the resulting hydrazone (VI) using an inorganic oxidizing agent such as manganese dioxide, potassium permanganate or potassium ferricyanide, or using an organic oxidizing agent such as 2,3-dichloro-5,6-dicyano-1,4-benzoquinone, by using a halogen solvent such as chloroform or methylene chloride or hydrocarbon-based solvent such as benzene, toluene or xylene, within a temperature range from room temperature to the reflux temperature of the solvent.

Since the quinone-based compounds of the present invention represented by the general formula (I) have superior electron transport properties, they are useful as so-called electron transport materials, and can be used particularly preferably as photosensitive layer materials of electrophotographic photoconductors and functional layer materials such as electron transport layers of organic EL.

The following provides a detailed explanation of specific embodiments of the electrophotographic photoconductor of the present invention with reference to the drawings.

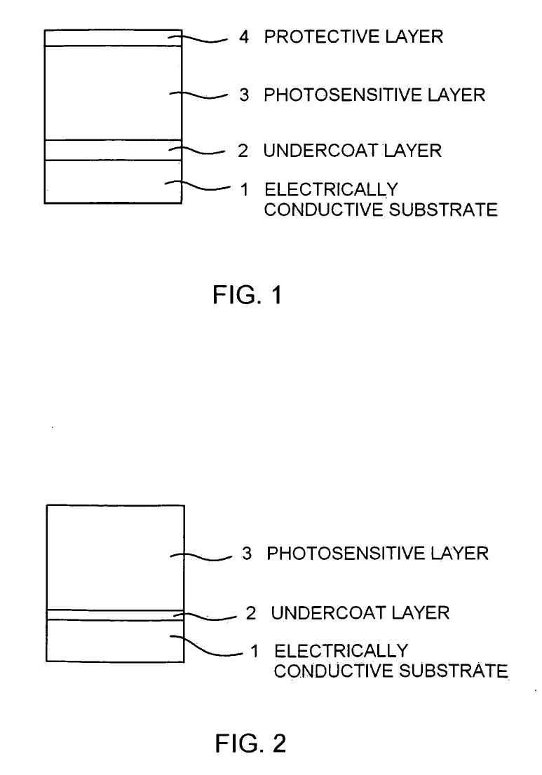

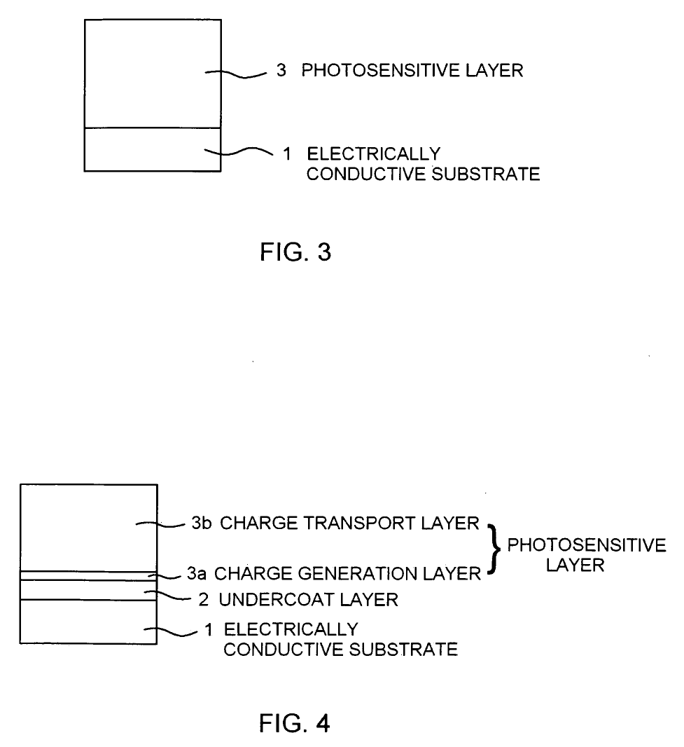

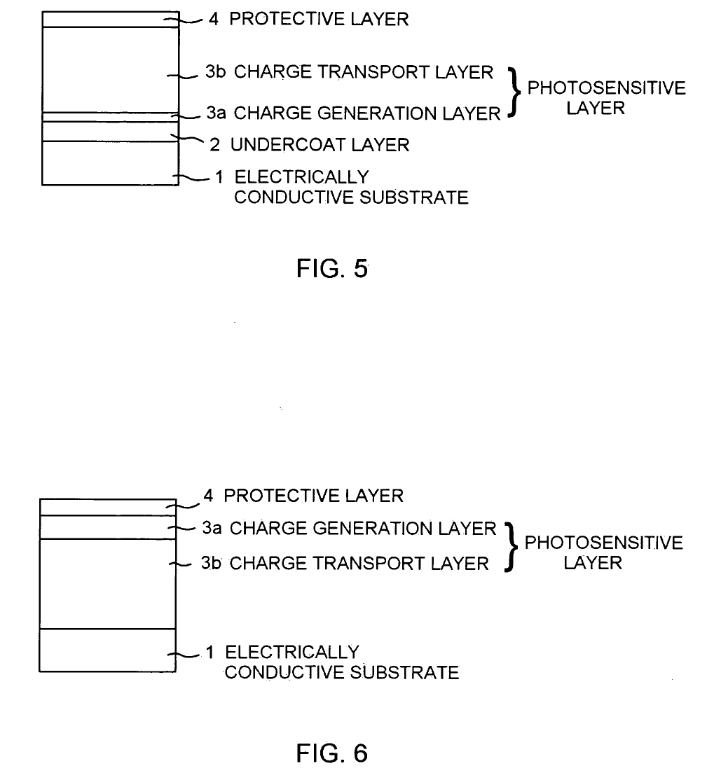

FIG. 1 is a schematic cross-sectional view showing an embodiment of the photoconductor of the present invention. Reference symbol 1 indicates an electrically conductive substrate, reference symbol 2 an undercoat layer, reference symbol 3 indicates a photosensitive layer, and reference symbol 4 indicates a protective layer, and the undercoat layer 2 and the protective layer 4 are provided as necessary. The photosensitive layer 3 may be a single-layer type comprising a single layer having both a charge-generating function and a charge-transporting function, or a separate function type in which layers separated into a charge generation layer and a charge transport layer are laminated. Photoconductors having the layer configurations shown in FIGS. 2 to 6 are shown as main specific examples. FIGS. 2 and 3 show a single-layer photoconductor in which the photosensitive layer is of the single-layer type. In addition, FIGS. 4 and 5 show a separate function multilayer photoconductor in which the photosensitive layer 3 on the undercoat layer 2 is formed by laminating a charge generation layer 3a and a charge transport layer 3b in that order. Moreover, FIG. 6 shows a separate function multilayer photoconductor in which the photosensitive layer 3 is formed by laminating the charge transport layer 3b and the charge generation layer 3a in that order, and which further has a protective layer 4 thereon. However, the present invention is not limited to photoconductors having the layer configurations shown in these drawings.

The electrically conductive substrate 1 serves as both an electrode of the photoconductor and a support for other layers, may have a cylindrical, plate-like or film-like shape, and may be composed of metal such as aluminum, stainless steel or nickel, or may be a conductively treated material on glass, resin and the like.

The undercoat layer 2 can be provided as necessary, is composed of a layer composed mainly of a resin or an oxide film such as alumite, and is provided for the purpose of, for example, preventing injection of unnecessary charge from the electrically conductive substrate into the photosensitive layer, covering defects in the substrate surface, and improving adhesion of the photosensitive layer. Examples of resin binders for the undercoat layer include polycarbonate resin, polyester resin, polyvinyl acetal resin, polyvinyl butyral resin, vinyl chloride resin, vinyl acetate resin, polyethylene, polypropylene, polystyrene, acrylic resin, polyurethane resin, epoxy resin, melamine resin, phenol resin, silicone resin, polyamide resin, polystyrene resin, polyacetal resin, polyarylate resin, polysulfone resin, polymers of methacrylic acid esters and copolymers thereof, and these can also be suitably used in combination. In addition, the resin binders may contain one or more types of microparticles of a metal oxide such as silicon oxide (silica), titanium oxide, zinc oxide, calcium oxide, aluminum oxide (alumina) or zirconium oxide, a sulfate such as barium sulfate or calcium sulfate, or a metal nitride such as silicon nitride or aluminum nitride, and the surface of these microparticles may be treated with a silane coupling agent, for example, or may be coated with a metal oxide film and the like.

Although depending on the composition thereof, the thickness of the undercoat layer can be arbitrarily set within a range that prevents the occurrence of detrimental effects such as increased residual potential during repeated continuous use, and is normally within the range of 0.01 to 50 μm. In addition, a plurality of the undercoat layer may be laminated.

The photosensitive layer 3 is composed of two layers mainly consisting of the charge generation layer 3a and the charge transport layer 3b in the case of a separate function type, or is composed of one layer in the case of a single-layer type. However, a plurality of layers having similar functions may also be laminated.

The charge generation layer 3a is formed by vacuum deposition of an inorganic or organic photoconductive substance, is formed by coating a material in which particles of an inorganic or organic photoconductive substance have been dispersed in a resin binder, and has a function of generating a charge by absorbing light. In addition, it is important that the charge generation efficiency thereof as well as the efficiency at which the generated charge is injected into the charge transport layer 3b both be high, and the generated charge is preferably able to be injected even in low electrical fields with little electrical field dependency.

Since the charge generation layer is only required to have a charge-generating function, the thickness thereof is determined by the light absorption coefficient of the charge generation material, and although is normally 0.1 to 50 μm, in the case of a multilayer photoconductor in which the charge transport layer is laminated on the charge generation layer, the thickness thereof is typically 5 μm or less and preferably 1 μm or less.

The charge generation layer consists mainly of a charge generation material, and can also be used following addition of a charge transport material and the like thereto. Examples of charge generation materials that can be used include phthalocyanine-based pigments, azo pigments, anthanthrone pigments, perylene pigments, perynone pigments, sqarylium pigments, thiapyrylium pigments and quinacridone pigments, and these pigments may also be suitably used in combination. In particular, preferable examples of azo pigments include disazo pigments and trisazo pigments, preferable examples of perylene pigments include N,N′-bis(3,5-dimethylphenyl)-3,4:9,10-perylenebis(carboxyimide), and preferable examples of phthalocyanine-based pigments include metal-free phthalocyanine, copper phthalocyanine and titanyl phthalocyanine.

In the present invention, among these charge generation materials, the phthalocyanine-based pigments are used particularly preferably. These phthalocyanines exist in various crystal forms, known examples of which include X-type metal-free phthalocyanine, τ-type metal-free phthalocyanine, ε-type copper phthalocyanine, α-type titanyl phthalocyanine, β-type titanyl phthalocyanine, Y-type titanyl phthalocyanine, amorphous titanyl phthalocyanine, and titanyl phthalocyanine described in Japanese Patent Application Laid-open No. H8-209023 having a maximum peak at 9.6° for Bragg angle 20 in a CuKα X-ray diffraction spectrum. Among these, the X-type metal-free phthalocyanine, α-type titanyl phthalocyanine and Y-type titanyl phthalocyanine described in Japanese Patent Application Laid-open No. 2001-228637, for example, and the titanyl phthalocyanine as claimed in the invention described in Japanese Patent Application Laid-open No. 2001-330972, are more preferable.

In addition, there are also charge generation materials having the ability to transport charge in addition to a charge-generating function. In particular, azo pigments and perylene pigments have electron transport properties, and can also be used as charge transport materials in addition to being used for the purpose of generating charge.

Examples of resin binders for the charge generation layer include polyvinyl acetal resin, polyvinyl butyral resin, vinyl chloride resin, vinyl acetate resin, silicone resin, polycarbonate resin, polyester resin, polyethylene, polypropylene, polystyrene, acrylic resin, polyurethane resin, epoxy resin, melamine resin, polyamide resin, polyacetal resin, polyarylate resin, polysulfone resin, polymers of methacrylic acid esters and copolymers thereof, and these can also be suitably used in combination. In addition, the same type of resins having different molecular weights may also be used. Furthermore, the content of the resin binder is 10 to 90% by weight, and preferably 20 to 80% by weight, based on the solid components of the charge generation layer.

Here, in the case of adding a charge transport material to the charge generation material, a charge transport material used for the charge transport layer explained below can be used. In addition, a compound represented by the general formula (I) as claimed in the present invention can also be used. Furthermore, the content of the charge transport material added to the charge transport layer is 0.1 to 50% by weight based on the solid components of the charge generation layer.

The charge transport layer 3b is a coated film composed of a material in which a charge transport material is dispersed in a resin binder, and demonstrates the functions of retaining the charge of the photoconductor in the form of an insulating layer in dark locations, and transporting charge injected from the charge generation layer when light is absorbed.

Although hole transport materials and electron transport materials are known to exist as charge transport materials, in the present invention, it is necessary to at least use a compound represented by the general formula (I) for the electron transport material. In addition, in the present invention, other electron transport materials and hole transport materials can also be used in addition to the compound represented by the general formula (I). Furthermore, the content of the charge transport material is 10 to 90% by weight and preferably 20 to 80% by weight based on the solid components of the charge transport layer, and although the effects of the invention are obtained provided a compound represented by the general formula (I) as claimed in the present invention is contained in the charge transport layer, the content thereof is preferably 10 to 60% by weight and more preferably 15 to 50% by weight based on the solid components of the charge transport layer.

Known electron transport materials can be used for the other electron transport materials, examples of which include electron-accepting substances and electron transport materials such as succinic anhydride, maleic anhydride, dibromosuccinic anhydride, phthalic anhydride, 3-nitrophthalic anhydride, 4-nitrbphthalic anhydride, pyromellitic anhydride, pyromellitic acid, trimellitic acid, trimellitic anhydride, phthalimide, 4-nitrophthalimide, tetracyanoethylene, tetracyanoquinodimethane, chloranil, bromanil, o-nitrobenzoic acid, trinitrofluorenone, quinone, benzoquinone, diphenoquinone, naphthoquinone, anthraquinone or stilbenequinone. Compounds described in Japanese Patent Application Laid-open No. 2000-314969 represented by structural formulas (ET1-1) to (ET1-16), (ET2-1) to (ET2-16), (ET3-1) to (ET3-12), (ET4-1) to (ET4-32), (ET5-1) to (ET5-8), (ET6-1) to (ET6-50), (ET7-1) to (ET7-14), (ET8-1) to (ET8-6), (ET9-1) to (ET9-4), (ET10-1) to (ET10-32), (ET11-1) to (ET11-16), (ET12-1) to (ET12-16), (ET13-1) to (ET13-16), (ET14-1) to (ET14-16), (ET15-1) to (ET15-16) and (ET-1) to (ET-42), for example, are particularly preferable. One type of these electron-accepting substances and electron transport materials can be used, or two or more types can be used in combination.

There are no particular limitations on the hole transport materials, and styryl compounds can be used preferably. Furthermore, styryl compounds in the present description refer to compounds having a structure represented by the following formula:

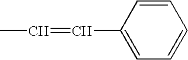

(wherein hydrogen atoms may be substituted).

Although examples of specific structures of the styryl compounds include structural formulas (HT1-1) to (HT1-136) and (HT2-1) to (HT2-70) described in Japanese Patent Application Laid-open No. 2000-314969, structural formulas (V-40) to (V-57) described in Japanese Patent Application Laid-open No. 2000-204083, and structural formulas (HT1-1) to (HT1-70) described in Japanese Patent Application Laid-open No. 2000-314970, the present invention is not limited to these compounds.

Examples of other compounds that can be used as hole transport materials include hydrazone compounds, pyrazoline compounds, pyrazolone compounds, oxadiazole compounds, oxazole compounds, arylamine compounds, benzidine compounds, stylbene compounds, polyvinylcarbazoles and polysilanes (examples of specific structures of which can be referred to in structural formulas (HT3-1) to (HT3-39), (HT4-1) to (HT4-20), (HT5-1) to (HT5-10) and (HT-1) to (HT-37) described in Japanese Patent Application Laid-open No. 2000-314969), and one type of these hole transport materials can be used or two or more types can be used in combination.

Examples of resin binders for the charge transport layer include polycarbonate resin, polyester resin, polyvinyl acetal resin, polyvinyl butyral resin, vinyl chloride resin, vinyl acetate resin, polyethylene, polypropylene, polystyrene, acrylic resin, polyurethane resin, epoxy resin, melamine resin, phenol resin, silicon resin, silicone resin, polyamide resin, polyacetal resin, polyarylate resin, polysulfone resin, polymers of methacrylic acid esters and copolymers thereof, and these can also be suitably used in combination. In particular, examples include polycarbonates having as the main repeating unit thereof a structural unit indicated in structural formulas (BD1-1) to (BD1-16) described in Japanese Patent Application Laid-open No. 2000-314969. In addition, other preferable examples of binder resins include polycarbonate resins having as the main repeating unit thereof the structural unit represented by one or more types of structural formulas (BD-1) to (BD-7) described in Japanese Patent Application Laid-open No. 2000-314969 or the following structural formula (BD-2) containing polysiloxane, and polyester resins, and two or more types of these resins may be used as a mixture thereof. In addition, mixtures of the same type of resins having different molecular weights may also be used. Furthermore, the content of the resin binder is 10 to 90% by weight and preferably 20 to 80% by weight based on the solid components of the charge transport layer.

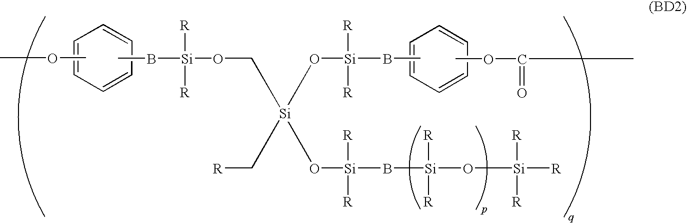

(In this formula, R may be the same or different and represents an alkyl group having 1 to 6 carbon atoms or optionally substituted aromatic hydrocarbon group having 6 to 12 carbon atoms, B represents (CH₂)ₓ, x represents an integer of 2 to 6, p represents an integer of 0 to 200 and q represents an integer of 1 to 50.)

The thickness of the charge transport layer is preferably within the range of 3 to 100 μm and more preferably 10 to 50 μm in order to maintain a practically effective surface potential.

Furthermore, although a typical separation function type of multilayer photoconductor has the charge transport layer laminated on the charge generation layer, the charge generation layer may also be laminated on the charge transport layer (see FIG. 6).

In the case of a single-layer photoconductor, a charge generation material, charge transport material and binder resin are used for the main components thereof. Charge transport materials consist of hole transport materials and electron transport materials, and in the present invention, it is necessary to at least use a compound represented by the general formula (I) for the electron transport material. In addition, other charge transport materials (electron transport materials or hole transport materials) can also be used in the same manner as in the case of the charge transport layer 3b. A hole transport material is preferably also used in combination. Compounds similar to the charge transport materials used in the charge generation layer 3a can be used for the charge generation material. In addition, binder resins similar to the binder resins used in the charge transport layer 3b and the charge generation layer 3a can be used for the binder resin.

Furthermore, the content of the charge generation material is 0.01 to 50% by weight, preferably 0.1 to 20% by weight, and more preferably 0.5 to 10% by weight based on the solid components of the single-layer photosensitive layer. In addition, the content of the charge transport material is 10 to 90% by weight and preferably 20 to 80% by weight based on the solid components of the single-layer photosensitive layer, and although the effects of the invention are obtained provided a compound represented by the general formula (I) as claimed in the present invention is contained in the single-layer photosensitive layer, the content thereof is preferably 10 to 60% by weight and more preferably 15 to 50% by weight based on the solid components of the single-layer photosensitive layer. The content of hole transport materials used in combination therewith is preferably 10 to 60% by weight and more preferably 20 to 50% by weight based on the solid components of the single-layer photosensitive layer. The content of the binder resin is normally 10 to 90% by weight and preferably 20 to 80% by weight based on the solid components of the single-layer photosensitive layer.

The thickness of the single-layer photosensitive layer is preferably within the range of 3 to 100 μm and preferably 10 to 50 μm in order to maintain a practically effective surface potential.

These photosensitive layers can also contain a degradation preventive agent such as an antioxidant or photostabilizer for the purpose of improving environmental resistance and stability to harmful light. Examples of compounds used for such purposes include chromanol derivatives such as tocopherol, esterified compounds, poly(arylalkane) compounds, hydroquinone derivatives, etherified compounds, dietherified compounds, benzophenone derivatives, benzotriazole derivatives, thioether compounds, phenylenediamine derivatives, phosphonate esters, phosphites, phenol compounds, hindered phenol compounds, linear amine compounds, cyclic amine compounds and hindered amine compounds.

In addition, the photosensitive layer can also contain a leveling agent such as silicone oil or fluorine-based oil for the purpose of improving leveling of the formed film and imparting lubricity.

Moreover, micro particles of a metal oxide such as silicon oxide (silica), titanium oxide, zinc oxide, calcium oxide, aluminum oxide (alumina) or zirconium oxide, a sulfate such as barium sulfate or calcium sulfate, or a metal nitride such as silicon nitride or aluminum nitride, microparticles of a fluorine-based resin such as ethylene tetrafluoride resin or a silicone resin, or polymers containing fluorine such as a fluorine-based comb-grafted polymer resin or polymers containing silicon, may be contained for the purpose of reducing the friction coefficient or imparting lubricity and the like.

Moreover, other known additives can also be contained as necessary within a range that does prominently impair electrophotographic properties.

The protective layer 4 can be provided as necessary for the purpose of improving printing durability and the like, and is composed of, for example, a layer mainly composed of a binder resin, an inorganic thin film deposited by vapor growth of amorphous carbon or amorphous silicon-carbon and the like, or a coating film formed by vapor deposition of silica or alumina and the like. Examples of resin binders that can be used include those used in the charge transport layer 3b and three-dimensional crosslinking resins such as siloxane resin. In addition, microparticles of a metal oxide such as silicon oxide (silica), titanium oxide, zinc oxide, calcium oxide, aluminum oxide (alumina) or zirconium oxide, a sulfate such as barium sulfate or calcium sulfate, or a metal nitride such as silicon nitride or aluminum nitride, microparticles of a fluorine-based resin such as ethylene tetrafluoride resin or a silicone resin, or polymers containing fluorine such as a fluorine-based comb-grafted polymer resin or polymers containing silicon having a network structure, may be contained in the binder resin for the purpose of improving electrical conductivity, reducing the friction coefficient, imparting lubricity and the like.

In addition, a charge transport material used in the photosensitive layer, an electron-accepting substance, an electron transport material or a compound represented by the general formula (I) can be contained for the purpose of imparting charge transport properties, or a leveling agent such as silicone oil or fluorine-based oil can be contained for the purpose of improving leveling of the formed film and imparting lubricity.

Although the protective layer may be used within a suitable range for the thickness thereof within a range that does not prominently impair the function of the photosensitive layer, normally the thickness of the protective layer s preferably within the range of 0.1 to 50 μm and more preferably 1 to 10 μm. In addition, a plurality of the protective layers may be laminated.

The following provides a detailed explanation of a method for preparing the photoconductor of the present invention (and is described in greater detail in, for example, Denshi Shashin Gakkaishi (Electrophotography), Vol. 28, No. 2, pp. 186 to 195, 1989, “OPC Kankotai no Seisan Gijutsu (The Manufacturing Technology of OPC Photoconductors)”).

In the case of forming the undercoat layer 2, the photosensitive layer 3 (the charge generation layer 3a and the charge transport layer 3b) and the protective layer 4 by coating, a coating solution is prepared by dissolving and dispersing the constituent materials in a suitable solvent followed by coating using a suitable coating method and removing the solvent by drying.

Principal examples of solvents used include alcohols such as methanol, ethanol, n-propanol, i-propanol, n-butanol or benzyl alcohol, ketones such as acetone, methyl ethyl ketone (MEK), methyl isobutyl ketone or cyclohexanone, amides such as dimethylformamide (DMF) or dimethylacetoamide, sulfoxides such as dimethylsulfoxide, cyclic or straight chain ethers such as tetrahydrofuran (THF), dioxane, dioxolane, diethyl ether, methyl cellosolve or ethyl cellosolve, esters such as methyl acetate, ethyl acetate or n-butyl acetate, aliphatic hydrocarbon halides such as methylene chloride, chloroform, carbon tetrachloride, dichloroethylene or trichloroethylene, mineral oils such as ligroin, aromatic hydrocarbons such as benzene, toluene or xylene, and aromatic hydrocarbon halides such as chlorobenzene or dichlorobenzene, and two or more types thereof may be also used as a mixture.

Examples of methods used to disperse and dissolve the coating solution mainly include known methods using a paint shaker (paint conditioner), ball mill, bead mill (sand grinder) such as a Dyno-mill and ultrasonic dispersion, while examples of coating methods that can be used mainly include known methods such as dip coating, ring coating (seal coating), spray coating, bar coating and blade coating.

In addition, although the drying temperature and drying time in the procedure described above can be suitably set in consideration of the type of solvent used, production cost and the like, the drying temperature is preferably set within a range from room temperature to 200° C., and the drying time is preferably set Within a range from 10 minutes to 2 hours. The drying temperature is more preferably within a range from the boiling point of the solvent to the boiling point plus 80° C. In addition, this drying is normally carried out at normal pressure or reduced pressure and in static or blowing air.

The electrophotographic photoconductor of the present invention can be used in a known electrophotographic process, can be preferably used in a typical electrophotographic process such as charging, exposure, development, transfer or fixing, and can be used in photocopiers, printers, fax machines and the like using these electrophotographic processes.

Here, charging processes consist of positive charging processes, in which a photoconductor is charged to a cathode, and negative charging processes, in which a photoconductor is charged to an anode. Although the photoconductor of the present invention can be used in a negative charging process, since it demonstrates particularly high sensitivity in a positive charging process, it is preferably used in a positive charging process. In particular, an electrophotographic photoconductor in which the photosensitive layer is in the form of a single-layer photosensitive layer containing a charge generation material, charge transport material and resin binder, containing an electron transport material and a hole transport material as electron transport materials, and containing at least one type of compound represented by the general formula (I) as claimed in the present invention as an electron transport material, has high sensitivity in a positive charging process.

Chargers used in the charging process consist of non-contact chargers using a corotron or scorotron, and chargers that carry out charging by contacting (or approaching) the photoconductor in the form of a roller or brush. The photoconductor of the present invention can be used in a process using either type of charger.

A light source having a wavelength band in which the photoconductor has sensitivity is normally used for the light source used in the exposure process, and white light such as that of a halogen lamp or fluorescent lamp, laser light or light from a light-emitting diode (LED) and the like is preferable. In particular, in the case of using phthalocyanine for the charge generation material, semiconductor laser light or LED light of about 600 to 800 nm is more preferable. In addition,in the case of using a compound having absorption at 450 nm or less for the charge generation material, semiconductor laser light or LED light of 450 nm or less can be used. In addition, an internal exposure system can also be used by using a translucent substrate for the electrically conductive substrate of the photoconductor.

The development process primarily consists of a dry development system using a dry toner, and a liquid development (wet development) system using a liquid toner, and the photoconductor of the present invention can be used in both types of systems. Furthermore, in the case of a liquid development system, it is desirable to employ a known technique for preventing the components of the photoconductor from dissolving into the solvent contained in the liquid toner.

In addition, although development processes consist of a reverse development system in which the toner is developed in exposed areas, and normal development system in which the toner is developed in unexposed areas, it is preferable to use a process employing a reverse development system particularly in the case of using phthalocyanine for the charge generation material.

Known electrophotographic processes consist of those having a cleaning process following a transfer process for the purpose of removing and dispersing non-transferred toner remaining on the photoconductor, and cleaner-less process not having such a cleaning process. The photoconductor of the present invention can be used in both processes.

In addition, known electrophotographic processes consist of those having an erase process based on exposure following a transfer process for the purpose of removing charge remaining on the photoconductor or equilibrating surface potential, and those not having such an erase process. The photoconductor of the present invention can be used in both processes.

In addition, the electrophotographic apparatus of the present invention is provided with the electrophotographic photoconductor of the present invention as previously described, and carries out the charging process by a positive charging process. In the electrophotographic apparatus of the present invention, there are no particular limitations on constituents other than those of the charging process, and is composed by a typical electrophotographic process as described above.

Although the following provides a more detailed explanation of the present invention through examples thereof, the present invention is not limited to these examples. Furthermore, spectral data indicated in the examples was measured using the apparatuses described below.

(1) ¹H-NMR spectra: DRX-500 (500 MHz) (Bruker Co., Ltd.)

(2) MASS spectra: POLARIS-Q (Thermo Electron Corp.)

### Synthesis Example 1

### Synthesis of Compound of Specific Example (I-8)

### (1) Synthesis of Bishydrazone

100.0 mL of concentrated hydrochloric acid were added to 28.0 g (124.2 mmol) of stannous chloride dihydrate and 737.3 mg (6.2 mmol) of tin followed by heating and stirring until the tin dissolved. 100.0 mL of concentrated hydrochloric acid were then added to 10.0 g (31.1 mmol) of 2,2′,5,5′-tetrachlorobenzidine followed by stirring for 1 hour at room temperature until amine crystals formed a slurry. After cooling to -20° C, 18 ml of an aqueous solution of 4.5 g (65.2 mmol) of sodium nitrite were dropped in over the course of 30 minutes followed by stirring for 1 hour. The above-mentioned stannous chloride solution was cooled to 5° C. and dropped into a diazoation solution over the course of 30 minutes. Following completion of addition, the solution was stirred for 1 hour, the resulting solid was filtered out with a glass filter and then washed with 100 ml of 1% aqueous hydrochloric acid solution. This wet solid was dissolved in 400 ml of N,N-dimethylformamide followed by the addition of 14.6 g (62.1 mmol) of 3,5-di-tert-butyl-4-hydroxybenzaldehyde and 38.2 g (465.8 mmol) of sodium acetate and stirring for 2 hours at room temperature. Following the addition of 200 ml of toluene and 400 ml of water, the insoluble matter was filtered out by cerite filtration. Following separation, the organic phase was washed twice with water and concentrated followed by purification by column chromatography and recrystallizing from methanol to obtain 18.0 g (22.9 mmol) of the target compound.

Yield: 73.9%, mp: 169 to 174° C.

¹H-NMR (500 MHz, CDCl₃): δ1.49 (s,36H), δ5.43 (s,2H), δ7.20 (s,2H), δ7.53 (s,4H), δ7.68 (s,2H), δ7.85 (s,2H), δ7.91 (s,2H)

MS (m/z): 784, 782, 553, 538, 307, 218, 188

### (2) Synthesis of Compound of Specific Example (I-8)

304 mL of toluene were added to 17.9 g (22.8 mmol) of the hydrazone compound obtained in Synthesis Example 1-(1) followed by the addition of 311.9 g (136.9 mmol) of manganese dioxide, heating to 70° C. and stirring for 5 hours. After cooling to room temperature, cerite filtration was carried out followed by concentrating and then purifying by column chromatography. The purified product was then recrystallized from toluene/acetonitrile solvent to obtain 13.5 g (17.2 mmol) of the target compound.

Yield: 75.5%, mp: 232 to 237° C.

¹H-NMR (500 MHz, CDCl₃): δ1.36 (s,18H), δ1.40 (s,18H), δ7.15 (d,J=2.2 Hz,2H), δ7.55 (s,2H), δ7.83 (s,2H), δ7.86 (s,2H), δ8.31 (d,J=2.2 Hz,2H)

MS (m/z): 780, 723, 721, 667, 215, 188

### Synthesis Example 2

### Synthesis of Compound of Specific Example (I-21 )

### (1) Synthesis of Bishydrazone

Synthesis was carried out in the same manner as Synthesis Example 1-(1) using 10.0 g (31.2 mmol) of 2,2′-bistrifluoromethylbenzidine to obtain 24.0 g (30.7 mmol) of the target compound.

Yield: 98.2%, mp: 223 to 226° C.

¹H-NMR (500 MHz, CDCl₃): δ1.48 (s,36H), δ5.38 (s,2H), δ7.18 (d,J=8.5 Hz,2H), δ7.23 (dd,J=8.5 Hz,2.4 Hz,2H)), δ7.42 (d,J=2.4 Hz,2H), δ7.51 (s,4H), δ7.61 (brs,2H), δ7.72 (s,2H)

MS (m/z): 783, 551, 319, 190

### (2) Synthesis of Compound of Specific Example (I-21)

Synthesis was carried out in the same manner as Synthesis Example 1-(2) using 5.00 g (6.39 mmol) of the hydrazone compound obtained in Synthesis Example 2-(1) to obtain 3.18 g (4.08 mmol) of the target compound.

Yield: 63.9%, mp: 149 to 154° C.

¹H-NMR (500 MHz, CDCl₃): δ1.37 (s,18H), δ1.39 (s,18H), δ7.16 (d,J=2.3 Hz,2H), δ7.50 (d,J=8.2 Hz,2H), δ7.73 (s,2H), δ8.01 (dd,J=2.3 Hz,8.2 Hz,2H), δ8.33 (s,2H), δ8.34 (d,2H)

MS (m/z): 778, 721, 665, 491

### Synthesis Example 3

### Synthesis of Compound of Specific Example (I-28)

(1) Synthesis of 2,2′-bistrifluoromethyl-5,5′-dibromobenzidine

20.0 g (62.5 mmol) of 2,2′-bistrifluoromethylbenzidine were dissolved in 100 mL of ethanol in a nitrogen atmosphere followed by dropping in 21.0 g (131.2 mmol) of bromine over the course of 1 hour while cooling with ice. After stirring for 1 hour at room temperature, toluene was added followed by washing the organic phase three times with water and then washing two times each with saturated aqueous sodium bicarbonate solution and water. Following concentration, the concentrate was recrystallized from hexane/toluene to obtain 11.5 g (24.1 mmol) of the target compound.

Yield: 38.5%, mp: 154 to 157° C.

¹H-NMR (500 MHz, CDCl₃): δ4.33 (s,4H), δ7.05 (s,2H), δ7.32 (s,2H)

MS (m/z): 478, 298

### (2) Synthesis of Bishydrazone

Synthesis was carried out in the same manner as Synthesis Example 1-(1) using 5.0 g (10.5 mmol) of 2,2′-bistrifluoromethyl-5,5′-dibromobenzidine to obtain 5.5 g (30.7 mmol) of the target compound.

Yield: 58.3%, mp: 153 to 155° C.

¹H-NMR (500 MHz, CDCl₃): δ1.49 (s,36H), δ5.43 (s,2H), δ7.38 (s,2H), δ7.55 (s,4H), δ7.88 (s,2H), δ7.93 (s,2H), δ8.02 (s,2H)

MS (m/z): 940, 708

### (3) Synthesis of Compound of Specific Example (I-28)

Synthesis was carried out in the same manner as Synthesis Example 1-(2) using 5.0 g (5.3 mmol) of the hydrazone compound obtained in Synthesis Example 3-(2) to obtain 3.7 g (3.95 mmol) of the target compound.

Yield: 74.7%, mp: 193 to 205° C.

¹H-NMR (500 MHz, CDCl₃): δ1.37 (s,18H), δ1.66 (s,18H), δ7.17 (d,J=2.1 Hz,2H), δ7.26 (s,2H), δ7.77 (s,2H), δ7.86 (s,2H), δ8.33 (d,J=2.1 Hz,2H)

MS (m/z): 936, 881

### Synthesis Example 4

### Synthesis of Compound of Specific Example (I-17)

### (1) Synthesis of Bishydrazone

Synthesis was carried out in the same manner as Synthesis Example 1-(1) using 7.00 g (33.0 mmol) of 2,2′-dimethylbenzidine to obtain 18.0 g (26.7 mmol) of the target compound.

Yield: 80.9%, mp: 204 to 208° C.

¹H-NMR (500 MHz, CDCl₃): δ2.07 (s,6H), δ5.33 (s,2H), δ6.94-6.97 (m,2H), δ6.99-7.03 (m,4H), δ7.44 (s,2H), δ7.50 (s,4H), δ7.68 (s,2H)

MS (m/z): δ75, 443, 218, 212

### (2) Synthesis of Compound of Specific Example (I-17)

Synthesis was carried out in the same manner as Synthesis Example 1-(2) using 18.0 g (26.7 mmol) of the hydrazone compound obtained in Synthesis Example 4-(1) to obtain 14.5 g (21.6 mmol) of the target compound.

Yield: 81.0%, mp: 169 to 173° C.

¹H-NMR (500 MHz, CDCl₃): δ1.68 (s,18H), δ1.40 (s,18H), δ2.21 (s,6H), δ7.15 (d,J=2.3 Hz,2H), δ7.29 (d,J=8.2 Hz,2H), δ7.70 (s,2H), δ7.81 (dd,J=1.7 Hz, 8.2 Hz, 2H), δ7.86 (d,J=1.7 Hz,2H), δ8.36 (d,J=2.3 Hz,2H)

MS (m/z): 670, 627, 613, 585

### Synthesis Example 5

### Synthesis of Compound of Specific Example (I-2)

(1) Synthesis of 2,2′-dibromobenzidine

Synthesis was carried out according to the method described in a non-patent document (J. Chem. Soc. Perkin Trans. I, 1982, 2289) using 15.0 g (74.3 mmol) of 3-bromonitrobenzene to obtain 5.0 g (14.6 mmol) of the target compound.

Yield: 39.4%, mp: 151 to 153° C. (lit. mp: 151 to 153° C.)

¹H-NMR (500 MHz, CDCl₃): δ3.74 (brs,4H), δ6.64 (dd,J=2.4,8.2 Hz,2H), δ6.97 (d,J=2.4 Hz,2H), δ7.00 (d,J=8.2 Hz,2H)

MS (m/z): 342, 261, 182

### (2) Synthesis of Bishydrazone

Synthesis was carried out in the same manner as Synthesis Example 1-(1) using 3.0 g (8.8 mmol) of 2,2′-dibromobenzidine to obtain 3.2 g (4.0 mmol) of the target compound.

Yield: 45.3%, mp: 193 to 196° C.

¹H-NMR (500 MHz, CDCl₃): δ1.48 (s,36H), δ5.37 (s,2H), δ7.05 (dd,J=8.3,2.2 Hz,2H), δ7.14 (d,J=8.3 Hz,2H), δ7.41 (d,J=2.2 Hz,2H), δ7.49 (s,2H), δ7.50 (s,4H), 7.68 (s,2H)

MS (m/z): 804, 573, 436, 341, 218

### (3) Synthesis of Compound of Specific Example (I-2)

Synthesis was carried out in the same manner as Synthesis Example 1-(2) using 3.0 g (3.7 mmol) of the bishydrazone compound obtained in Synthesis Example 5-(2) to obtain 1.9 g (2.3 mmol) of the target compound.

Yield: 62.9%, mp: 202 to 205° C.

¹H-NMR (500 MHz, CDCl₃): δ1.37 (s,18H), δ1.39 (s,18H), δ7.15 (d,J=2.2 Hz,2H), δ7.45 (d,J=8.1 Hz,2H), δ7.70 (s,2H), δ7.95 (dd,J=1.8,8.1 Hz,2H), δ8.23 (d,J=1.8 Hz,2H), δ8.32 (d,J=2.2 Hz,2H)

MS (m/z): 801, 745

### Photoconductor Example 1

A plate-shaped photoconductor for evaluation of electrical properties and a drum-shaped photoconductor for evaluation of printing were respectively produced. Furthermore, the term “parts” hereinafter refers to part(s) by weight.

An undercoat layer solution prepared as described below was respectively coated onto the external surfaces of an aluminum plate (3 cm×10 cm, thickness: 1 mm) and an aluminum cylinder (outer diameter: 30 mm, length: 247.5 mm, thickness: 0.75 mm) by dip coating, followed by drying the plate and cylinder for 60 minutes at 100° C. to remove the solvent and respectively form an undercoat layer having a thickness of 0.1 μm.

### Preparation of Undercoat Layer Solution

a1) Vinyl chloride-vinyl acetate copolymer resin (SOLBIN A: (Nisshin Chemical Industry Co., Ltd.)) 3 parts (30 g)

The undercoat layer material a1) was dissolved by stirring with 97 parts (970 g) of methyl ethyl ketone (MEK) to prepare the undercoat layer solution.

Next, a single-layer photosensitive layer dispersion prepared as described below was coated onto the undercoat layers by dip coating in the case of the plate or by ring coating in the case of the cylinder, followed by removing the solvent by respectively drying for 60 minutes at 100° C. and forming single-layer photosensitive layers having a thickness of 30 μm to produce electrophotographic photoconductors.

### Preparation of Single-Layer Photosensitive Layer Dispersion

b1) Charge generation material: X-type metal-free phthalocyanine (see FIG. 2 of Japanese Patent Application Laid-open No. 2001-228637) 0.2 parts (0.1 g)

b2) Hole transport material: Styryl compound represented by the following structural formula (HT2-2):

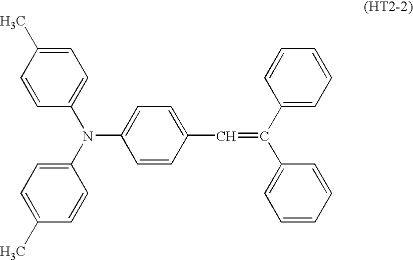

((HT2-2) in Japanese Patent Application Laid-open No. 2000-314969) 6.5 parts (3.25 g)

b3) Electron transport material: Compound represented by the formula (I-8) (Synthesis Example 1): 4.5 parts (2.25 g)

b4) Antioxidant: 3,5-di-tert-4-hydroxytoluene (BHT) 1.0 part (0.5 g)

b5) Silicone oil (KP-340: Shin-Etsu Chemical Co., Ltd.) 0.01 part (0.005 g)

b6) Binder resin: Bisphenol Z-type polycarbonate resin (Panlite TS2050: Teijin Chemicals, Ltd.) ((BD1-1) in Japanese Patent Application Laid-open No. 2000-314969) 8 parts (4 g)

b7) Binder resin: Polysiloxane-containing copolymer polycarbonate resin (Tough Z G400, Idemitsu Kosan Co., Ltd.) (see paragraph [0028] of Japanese Patent Application Laid-open No. 2001-142235) 1 part (0.5 g)

The photosensitive layer materials b1) to b7) were placed in a 100 ml plastic bottle along with 100 parts (50 g) of methylene chloride solvent and 50 g of stainless steel beads (diameter: 3 mm) and subjected to dispersion treatment for 60 minutes with a paint conditioner (Model 5400, Red Devil Equipment Co., USA) followed by separating the stainless steel beads to prepare the single-layer photosensitive layer dispersion.

### Photoconductor Example 2

A photoconductor was produced in the same manner as Photoconductor Example 1 with the exception of using 4.5 parts of the compound represented by the formula (I-2) (Synthesis Example 2) for the electron transport material instead of 4.5 parts of the compound represented by the formula (I-8) used for the electron transport material in the composition of the single-layer photosensitive layer dispersion used in Photoconductor Example 1.

### Photoconductor Example 3

A photoconductor was produced in the same manner as Photoconductor Example 1 with the exception of respectively using 3 parts instead of 4.5 parts of the compound represented by the formula (I-8) used for the electron transport material in the composition of the single-layer photosensitive layer dispersion used in Photoconductor Example 1, and using 9.5 parts instead of 8 parts of the bisphenol Z-type polycarbonate resin.

### Photoconductor Example 4

A photoconductor was produced in the same manner as Photoconductor Example 1 with the exception of using 6.5 parts of the styryl compound represented by the following structural formula (HT1-101):

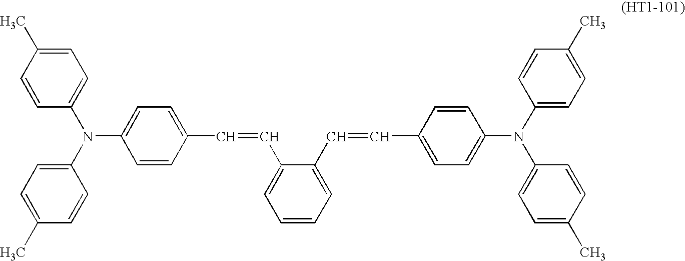

((HT1-101) indicated in Japanese Patent Application Laid-open No. 2001-314969) for the hole transport material instead of 6.5 parts of the styryl compound represented by the formula (HT2-2) used in the composition of the single-layer photosensitive layer dispersion used in Photoconductor Example 1.

### Photoconductor Example 5

A photoconductor was produced in the same manner as Photoconductor Example 1 with the exception of using 6.5 parts of the diamine compound represented by the following structural formula (HT-11):

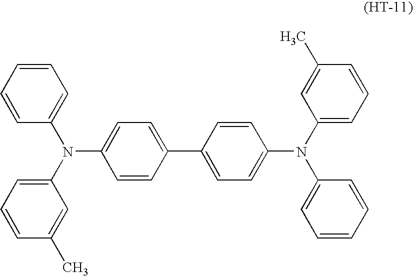

((HT-11) indicated in Japanese Patent Application Laid-open No. 2001-314969) for the hole transport material instead of 6.5 parts of the styryl compound represented by the formula (HT2-2) used in the composition of the single-layer photosensitive layer dispersion used in Photoconductor Example 1.

### Photoconductor Example 6

A photoconductor was produced in the same manner as Photoconductor Example 1 with the exception using a single-layer photosensitive layer dispersion 2 described below instead of the single-layer photosensitive layer dispersion used in Photoconductor Example 1.

### Preparation of Single-Layer Photosensitive Layer Dispersion 2

b8) α-Type titanyl phthalocyanine (see FIG. 3 in Japanese Patent Application Laid-open No. 2001-228637) 0.3 parts (0.15 g)

b9) Hole transport material: Compound represented by the structural Formula (HT2-2) 7 parts (3.5 g)

b10) Electron transport material: Compound represented by the formula (I-8) 4 parts (2 g)

b11) Silicone oil (KP-340) 0.01 part (0.005 g)

b12) Binder resin: (Panlite TS2050) 9 parts (4.5 g)

The photosensitive layer materials b8) to b12) were placed in a 100 ml plastic bottle along with 90 parts (45 g) of THF solvent and 50 g of stainless steel beads (diameter: 3 mm) and subjected to dispersion treatment for 60 minutes with a paint conditioner (Model 5400, Red Devil Equipment Co., USA) followed by separating the stainless steel beads to prepare the single-layer photosensitive layer dispersion 2.

### Photoconductor Example 7

A photoconductor was produced in the same manner as Photoconductor Example 6 with the exception of using 4 parts of the compound represented by the formula (I-21) (Synthesis Example 2) for the electron transport material instead of 4 parts of the compound represented by the formula (I-8) used for the electron transport material in the composition of the single-layer photosensitive layer dispersion used in Photoconductor Example 6.

### Photoconductor Example 8

A photoconductor was produced in the same manner as Photoconductor Example 1 with the exception of using 4.5 parts of the compound represented by the formula (I-28) (Synthesis Example 3) for the electron transport material instead of 4.5 parts of the compound represented by the formula (I-8) used for the electron transport material in the composition of the single-layer photosensitive layer dispersion used in Photoconductor Example 1.

### Photoconductor Example 9

A photoconductor was produced in the same manner as Photoconductor Example 1 with the exception of using 4.5 parts of the compound represented by the formula (I-17) (Synthesis Example 4) for the electron transport material instead of 4.5 parts of the compound represented by the formula (I-8) used for the electron transport material in the composition of the single-layer photosensitive layer dispersion used in Photoconductor Example 1.

### Photoconductor Example 10

A photoconductor was produced in the same manner as Photoconductor Example 1 with the exception of using 4.5 parts of the compound represented by the formula (I-2) (Synthesis Example 5) for the electron transport material instead of 4.5 parts of the compound represented by the formula (I-8) used for the electron transport material in the composition of the single-layer photosensitive layer dispersion used in Photoconductor Example 1.

### Photoconductor Reference Example 1

A photoconductor was produced in the same manner as Photoconductor Example 1 with the exception of using 4.5 parts of the compound represented by the following structural formula (ET-5)

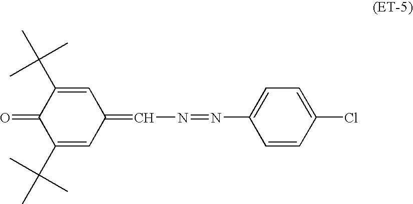

for the electron transport material instead of 4.5 parts of the compound represented by the formula (I-8) used for the electron transport material in the composition of the single-layer photosensitive layer dispersion used in Photoconductor Example 1.

### Photoconductor Reference Example 2

A photoconductor was produced in the same manner as Photoconductor Example 6 with the exception of using 4 parts of the compound represented by the structural formula (ET-5) for the electron transport material instead of 4 parts of the compound represented by the formula (I-8) used for the electron transport material in the composition of the single-layer photosensitive layer dispersion used in Photoconductor Example 6.

### Evaluation of Photoconductor Examples 1 to 10 and Photoconductor Reference Examples 1 and 2

Electrical properties of the plate-like photoconductors were evaluated with an EPA-8100 electrostatic copying paper testing apparatus manufactured by Kawaguchi Electric Works Co., Ltd.

The photoconductors were charged in the dark to a surface potential of about +700 V in an environment at a temperature of 28° C. and humidity of 46% followed by determination of the surface potential retention rate Vk5 after 5 seconds using the following equation.

Retention rate Vk5(%)=(V5/V0)×100

V0: Surface potential immediately after charging

V5: Surface potential after 5 seconds

Next, the surface potential was adjusted to +600 V, and the photoconductors were exposed for 5 seconds to monochromatic light at 1.0 μW/cm² obtained by splitting light from a halogen lamp by a filter, followed by determining sensitivity E1/2 (μJ/cm²) in the form of the amount of exposure required to lower the surface potential by half (+300 V), and then determining the residual potential Vr (V) in the form of the surface potential 5 seconds after exposure.

In addition, the appearances of the drum-shaped photoconductors produced were observed visually. The results of these evaluations are shown in Table 1 below.

TABLE 1

| | Retention | Sensitivity | Residual | |
|---|---|---|---|---|
| | rate Vk5 | E½ | potential Vr | Photoconductor |
| | (%) | (μJ/cm²) | (V) | appearance |
| Photoconductor | 88.5 | 0.24 | 20 | Good |
| Example 1 | | | | |
| Photoconductor | 83.9 | 0.30 | 25 | Good |
| Example 2 | | | | |
| Photoconductor | 86.3 | 0.28 | 26 | Good |
| Example 3 | | | | |
| Photoconductor | 82.0 | 0.22 | 17 | Good |
| Example 4 | | | | |
| Photoconductor | 77.5 | 0.35 | 40 | Good |
| Example 5 | | | | |
| Photoconductor | 81.0 | 0.13 | 18 | Good |
| Example 6 | | | | |
| Photoconductor | 80.0 | 0.15 | 31 | Good |
| Example 7 | | | | |
| Photoconductor | 85.0 | 0.29 | 25 | Good |
| Example 8 | | | | |
| Photoconductor | 87.1 | 0.23 | 20 | Good |
| Example 9 | | | | |
| Photoconductor | 86.9 | 0.20 | 19 | Good |
| Example 10 | | | | |
| Photoconductor | 87.7 | 0.30 | 31 | Good |
| Reference | | | | |
| Example 1 | | | | |
| Photoconductor | 83.8 | 0.15 | 37 | Good |
| Reference | | | | |
| Example 2 | | | | |

As shown in Table 1 above, in a comparison between Photoconductor Examples 1, 2 and 8 to 10 and Photoconductor Reference Example 1, and in a comparison between Photoconductor Examples 6 and 7 and Photoconductor Reference Example 2 (comparisons in which only the electron transport materials differ while all other conditions, including constituent ratios, are the same), the photoconductors of the examples demonstrated high sensitivity, low residual potential and superior electrical properties as compared with the photoconductors of the reference examples.

In addition, in order to evaluate durability with respect to actual printing, the drum-shaped photoconductors of Photoconductor Examples 1 to 5 and 8 to 10 and Photoconductor Reference Example 1 were mounted on an HL-5040 laser printer manufactured by Brother Industries, Ltd., and a solid black image, solid white image and halftone image were printed in an environment at a temperature of 27° C. and humidity of 45%. Continuing, 10,000 pages of images having a printing ratio of about 5% were printed followed by again printing solid black, solid white and halftone images and evaluating the images after printing 10,000 pages. (The drum-shaped photoconductors of Photoconductor Examples 6 and 7 and Photoconductor Reference Example 2 were not evaluated for durability since they were unsuitable for the printer used because of their excessively high sensitivity.) As a result, good images were obtained for both initial printing and after printing 10,000 pages for the photoconductors of Photoconductor Examples 1 to 4 and 8 to 10. On the other hand, although the photoconductors of Photoconductor Example 5 and Photoconductor Reference Example 1 demonstrated good initial printing, halftone images obtained after printing 10,000 pages were blurred.

1. A novel quinone compound having a structure represented by general formula (I): 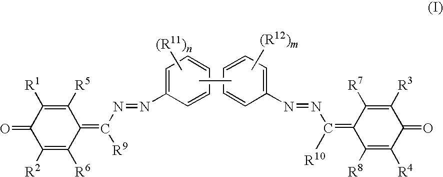
wherein R¹ to R⁸ may be the same or different and represent a hydrogen atom or an optionally substituted alkyl group or a cycloalkyl group having 1 to 6 carbon atoms,
R⁹ and R¹⁰ may be the same or different and represent a hydrogen atom, an optionally substituted alkyl group having 1 to 6 carbon atoms, an optionally substituted aryl group or an optionally substituted heterocyclic group,
R¹ and R⁵, R² and R⁶, R³ and R⁷ and R⁴ and R⁸ may be mutually bonded to form a ring,
R¹¹ and R¹² may be the same or different and represent a halogen atom, an optionally substituted alkyl group, having 1 to 6 carbon atoms, an alkoxy group having 1 to 6 carbon atoms, an alkyl halide group having 1 to 6 carbon atoms, an hydroxyl group, a nitro group, an optionally substituted aryl group or an optionally substituted heterocyclic group,
n and m represent integers of 0 to 4,
two or more R¹¹ may be the same or different and two or more R¹¹ may be mutually bonded to form a ring in the case n is 2 or more,
two or more R¹² may be the same or different and two or more R¹² may be mutually bonded to form a ring in the case m is 2 or more, and
substituents represent halogen atoms, alkyl groups having 1 to 6 carbon atoms, alkoxy groups having 1 to 6 carbon atoms, alkyl halide groups having 1 to 6 carbon atoms, hydroxyl groups, nitro groups, aryl groups or heterocyclic groups.

2.-6. (canceled)

7. An electrophotographic photoconductor, comprising:
an electrically conductive substrate;
a photosensitive layer containing a charge generation material and a charge transport material provided on the electrically conductive substrate,
wherein the photosensitive layer contains at least one type of compound having a structure represented by t general formula (I): 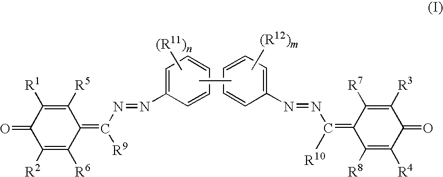
wherein R¹ to R⁸ may be the same or different and represent a hydrogen atom or an optionally substituted alkyl group or a cycloalkyl group having 1 to 6 carbon atoms,
R⁹ and R¹⁰ may be the same or different and represent a hydrogen atom, an optionally substituted alkyl group having 1 to 6 carbon atoms, an optionally substituted aryl group or an optionally substituted heterocyclic group,
R¹ and R⁵, R² and R⁶, R³ and R⁷ and R⁴ and R⁸ may be mutually bonded to form a ring,
R¹¹ and R¹² may be the same or different and represent a halogen atom, an optionally substituted alkyl group having 1 to 6 carbon atoms, an alkoxy group having 1 to 6 carbon atoms, an alkyl halide group having 1 to 6 carbon atoms, an hydroxyl group, a nitro group, an optionally substituted aryl group or an optionally substituted heterocyclic group,
n and m represent integers of 0 to 4,
two or more R¹¹ may be the same or different and two or more R¹¹ may be mutually bonded to form a ring in the case n is 2 or more,
two or more o R¹² may be the same or different and two or more R¹² may be mutually bonded to form a ring in the case m is 2 or more, and substituents represent halogen atoms, alkyl groups having 1 to 6 carbon atoms, alkoxy groups having 1 to 6 carbon atoms, alkyl halide groups having 1 to 6 carbon atoms, hydroxyl groups, nitro groups, aryl groups or heterocyclic group.

8. The electrophotographic photoconductor according to claim 7, wherein the photosensitive layer is a single-layer photosensitive layer containing a charge generation material, a charge transport material and a resin binder, wherein the charge transport material comprises an electron transport material and a hole transport material, and wherein the electron transport material comprises at least one type of compound having a structure represented by the general formula (I).

9. The electrophotographic photoconductor according to claim 8, wherein the hole transport material comprises a styryl compound.

10. The electrophotographic photoconductor according to claim 9, wherein the charge generation material comprises a phthalocyanine compound.

11. The electrophotographic photoconductor according to claim 8, wherein the charge generation material comprises a phthalocyanine compound.

12. The electrophotographic photoconductor according to claim 7, wherein the hole transport material comprises a styryl compound.

13. The electrophotographic photoconductor according to claim 12, wherein the charge generation material comprises a phthalocyanine compound.

14. The electrophotographic photoconductor according to claim 7, wherein the charge generation material comprises a phthalocyanine compound.

15. An electrophotographic apparatus which carries out a positive charging process, the apparatus comprising:
an electrophotographic photoconductor comprised of:
an electrically conductive substrate;
a photosensitive layer containing a charge generation material and a charge transport material provided on the electrically conductive substrate,
wherein the photosensitive layer contains at least one type of compound having a structure represented by general formula (I): 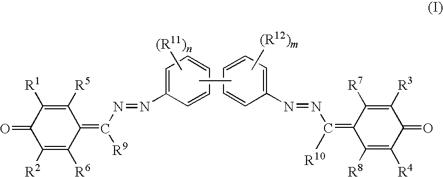
wherein R¹ to R⁸ may be the same or different and represent a hydrogen atom or an optionally substituted alkyl group or a cycloalkyl group having 1 to 6 carbon atoms,
R⁹ and R¹⁰ may be the same or different and represent a hydrogen atom, an optionally substituted alkyl group having 1 to 6 carbon atoms, an optionally substituted aryl group or an optionally substituted heterocyclic group,
R¹ and R⁵, R² and R⁶, R³ and R⁷ and R⁴ and R⁸ may be mutually bonded to form a ring,
R¹¹ and R¹² may be the same or different and represent a halogen atom, an optionally substituted alkyl group having 1 to 6 carbon atoms, an alkoxy group having 1 to 6 carbon atoms, an alkyl halide group having 1 to 6 carbon atoms, an hydroxyl group, a nitro group, an optionally substituted aryl group or an optionally substituted heterocyclic group,
n and m represent integers of 0 to 4,
two or more R¹¹ may be the same or different and two or more R¹¹ may be mutually bonded to form a ring in the case n is 2 or more,
two or more o R¹² may be the same or different and two or more R¹² may be mutually bonded to form a ring in the case m is 2 or more, and
substituents represent halogen atoms, alkyl groups having 1 to 6 carbon atoms, alkoxy groups having 1 to 6 carbon atoms, alkyl halide groups having 1 to 6 carbon atoms, hydroxyl groups, nitro groups, aryl groups or heterocyclic group.
